(19) United States
(12) Patent Application Publication
(10) Pub. No.: US 2021/0309046 A1
(43) Pub. Date: Oct. 7, 2021

(54) METHOD FOR MANUFACTURING DECORATIVE FILM FOR MOLDING, MOLDING METHOD, DECORATIVE FILM FOR MOLDING, MOLDED PRODUCT, AUTOMOBILE EXTERIOR PLATE, AND ELECTRONIC DEVICE

(71) Applicant: FUJIFILM CORPORATION, Tokyo (JP)

(72) Inventors: Takeshi HAMA, Kanagawa (JP); Yuichi HAYATA, Kanagawa (JP); Makoto ISHIGURO, Kanagawa (JP)

(21) Appl. No.: 17/343,750

(22) Filed: Jun. 10, 2021

Related U.S. Application Data
(63) Continuation of application No. PCT/JP2019/049024, filed on Dec. 13, 2019.

(30) Foreign Application Priority Data
Dec. 14, 2018 (JP) 2018-234493

(51) Int. Cl. B44C 1/18; B29C 45/14

(52) U.S. Cl. CPC B44C 1/18; B29L 2031/3005; B29C 45/14811; B29C 45/14688

(57) ABSTRACT

In one embodiment, a method for manufacturing a decorative film for molding and a molding method include, in the following order, forming, on a base material, a liquid crystal layer including a cholesteric liquid crystal compound and a photoisomerization compound, photoisomerizing the liquid crystal layer, and curing the liquid crystal layer. In one embodiment, a decorative film for molding includes, on a base material, a liquid crystal layer including a cholesteric liquid crystal compound and a photoisomerization compound, in which the cured liquid crystal layer has a plurality of regions which are different from each other in terms of a photoisomerization proportion of the photoisomerization compound. A molded product using the decorative film for molding, an automobile exterior plate, and an electronic device are also provided.

### CROSS-REFERENCE TO RELATED APPLICATIONS

This application is a continuation application of International Application No. PCT/JP2019/049024, filed Dec. 13, 2019, the disclosure of which is incorporated herein by reference in its entirety. Further, this application claims priority from Japanese Patent Application No. 2018-234493, filed Dec. 14, 2018, the disclosure of which is incorporated herein by reference in its entirety.

### BACKGROUND OF THE INVENTION

### 1. Field of the Invention

The present disclosure relates to a method for manufacturing a decorative film for molding, a molding method, a decorative film for molding, a molded product, an automobile exterior plate, and an electronic device.

### 2. Description of the Related Art

The surface of base materials such as paper, wood, plastic, metal, glass, inorganic material, and the like is coated to protect the surface by imparting various performances such as hardness, scratch resistance, abrasion resistance, chemical resistance, organic solvent resistance, and the like, or is painted for the purpose of designability.

In addition, a coating agent is applied to the surface of the molded product after molding for the purpose of protecting the surface of plastic molded products used for cases of home appliances, personal computers, mobile phones, and the like, or painting is performed for the purpose of designability.

In recent years, instead of the above-described coating or painting, a method of transferring a decorative layer to a molded product by a step of preparing a decorative layer as a decorative film for molding, placing the decorative film for molding on a mold, and then molding the decorative film for molding using a resin for molding.

Examples of a decorative film in the related art include decorative films disclosed in JP2014-019064A.

JP2014-019064A discloses a decorative film including an adhesive layer, a decorative layer formed from a base paint, and a thermoplastic film layer, in which the base paint contains 12 to 80 parts by mass of a flaky metal powder (B) having an average particle diameter of 15 to 50 μm and 1 to 25 parts by mass of spherical particles (C) having an average particle diameter of 2 to 20 μm with respect to 100 parts by mass of the solid content of a film-forming resin (A) including an acrylic resin emulsion (A-1), and the base paint is a water-based metallic paint in which the usage ratio of the flaky metal powder (B) and the spherical particles (C) is 15:1 to 2:1.

### SUMMARY OF THE INVENTION

An object to be achieved by the embodiment of the present invention is to provide a method for manufacturing a decorative film for molding, which can obtain a decorative film for molding having a small change in tint after molding.

An object to be achieved by another embodiment of the present invention is to provide a molding method which can obtain a molded product having a small change in tint.

An object to be achieved by still another embodiment of the present invention is to provide a decorative film for molding, which has a small change in tint after molding.

An object to be achieved by yet another embodiment of the present invention is to provide a molded product using the above-described decorative film for molding, and an automobile exterior plate and an electronic device.

The methods for achieving the above-described objects include the following aspects.

<1> A method for manufacturing a decorative film for molding, comprising, in the following order:

forming, on a base material, a liquid crystal layer comprising a cholesteric liquid crystal compound and a photoisomerization compound;

photoisomerizing the liquid crystal layer; and curing the liquid crystal layer.

<2> The method for manufacturing a decorative film for molding according to <1>, in which, in the photoisomerization, a part of a region of the liquid crystal layer is isomerized.

<3> The method for manufacturing a decorative film for molding according to <2>, in which a difference between a wavelength of a maximum reflectance of a region where the photoisomerization is most advanced in the manufactured decorative film for molding and a wavelength of a maximum reflectance of a region where the photoisomerization is least advanced in the manufactured decorative film for molding is 50 nm or more.

<4> The method for manufacturing a decorative film for molding according to <2> or <3>,

in which, at least a part of a region of the manufactured decorative film for molding is stretched to a stretching ratio of 10% to 250% in terms of area ratio, and a difference between a wavelength of a maximum reflectance of the stretched region and a wavelength of a maximum reflectance of the region where the photoisomerization is least advanced is less than 50 nm.

<5> The method for manufacturing a decorative film for molding according to any one of <1> to <4>,

in which the manufactured decorative film for molding comprises a region where a wavelength of a maximum reflectance is within a range of 380 nm to 780 nm.

<6> The method for manufacturing a decorative film for molding according to any one of <1> to <5>,

in which the cholesteric liquid crystal compound in the liquid crystal layer has a radically polymerizable group.

<7> The method for manufacturing a decorative film for molding according to <6>,

in which the cured liquid crystal layer in the manufactured decorative film for molding has a density of crosslinking formed from the radically polymerizable group of 0.15 mol/L to 0.5 mol/L.

<8> The method for manufacturing a decorative film for molding according to any one of <1> to <7>,

in which a decorative film for molding, which is used for an exterior of an automobile, is manufactured.

<9> The method for manufacturing a decorative film for molding according to any one of <1> to <7>,

in which a decorative film for molding, which is used for decorating a housing panel of an electronic device, is manufactured.

<10> A molding method comprising:

molding a decorative film for molding manufactured by the method for manufacturing a decorative film for molding according to any one of <1> to <9>.

<11> A decorative film for molding comprising:

a cured liquid crystal layer, which is formed by curing a liquid crystal layer comprising a cholesteric liquid crystal compound and a photoisomerization compound, on a base material,

in which the cured liquid crystal layer has a plurality of regions which are different from each other in terms of a photoisomerization proportion of the photoisomerization compound.

<12> The decorative film for molding according to <11>, comprising

at least two regions wherein a difference in wavelength of a maximum reflectance between the at least two regions is 50 nm or more.

<13> The decorative film for molding according to <11> or <12>,

in which the decorative film for molding is a decorative film for molding used for an exterior of an automobile.

<14> The decorative film for molding according to <11> or <12>,

in which the decorative film for molding is a decorative film for molding used for decorating a housing panel of an electronic device.

<15> A molded product obtained by molding the decorative film for molding according to <13> or <14>.

<16> The molded product according to <15>, comprising a plurality of regions which are different from each other in terms of a photoisomerization proportion of the photoisomerization compound, and having at least two regions, wherein a difference in wavelength of the maximum reflectance between the at least two regions is 50 nm or more.

<17> An automobile exterior plate comprising:

the molded product according to <15> or <16>.

<18> An electronic device comprising:

the molded product according to <15> or <16>.

According to the embodiment of the present invention, it is possible to provide a method for manufacturing a decorative film for molding, which can obtain a decorative film for molding having a small change in tint after molding.

According to another embodiment of the present invention, it is possible to provide a molding method which can obtain a molded product having a small change in tint.

According to still another embodiment of the present invention, it is possible to provide a decorative film for molding, which has a small change in tint after molding.

According to yet another embodiment of the present invention, it is possible to provide a molded product using the above-described decorative film for molding, and an automobile exterior plate and an electronic device.

### BRIEF DESCRIPTION OF THE DRAWINGS

FIG. 1 is a diagram showing a mask pattern of a mask film used in Examples 20 and 22.

FIG. 2 is a diagram showing a mask pattern of a mask film used in Example 21.

FIG. 3A is a view showing a rear housing panel of a smartphone.

FIG. 3B is a view showing a side surface of the rear housing panel of the smartphone.

### DESCRIPTION OF THE PREFERRED EMBODIMENTS

Hereinafter, the contents of the present disclosure will be described in detail. The description of constituent elements below is made based on representative embodiments of the present disclosure in some cases, but the present disclosure is not limited to such embodiments.

In the present specification, the numerical ranges shown using “to” indicate ranges including the numerical values described before and after “to” as a lower limit value and an upper limit value.

In numerical ranges described in stages in the present specification, an upper limit value or a lower limit value described in one numerical range may be replaced with an upper limit value or a lower limit value of a numerical range described in another stage. In addition, in the numerical ranges described in the present specification, the upper limit value or the lower limit value of the numerical ranges may be replaced with the values shown in examples.

Furthermore, in the present specification, in a case where a plurality of substances corresponding to each component in a composition is present, the amount of each component in the composition means the total amount of the plurality of substances present in the composition, unless otherwise specified.

In the present specification, the term “step” includes not only the independent step but also a step in which intended purposes are achieved even in a case where the step cannot be precisely distinguished from other steps.

In the present specification, the “total solid content” refers to a total mass of components obtained by removing a solvent from the whole composition of the composition. In addition, the “solid content” is a component obtained by removing a solvent as described above, and for example, the component may be solid or may be liquid at 25° C.

In a case where substitution or unsubstitution is not noted in regard to the notation of a “group” (atomic group) in the present specification, the “group” includes not only a group not having a sub stituent but also a group having a sub stituent. For example, the concept of an “alkyl group” includes not only an alkyl group not having a substituent (unsubstituted alkyl group) but also an alkyl group having a substituent (substituted alkyl group).

In addition, in the present disclosure, “% by mass” has the same definition as that for “% by weight”, and “part by mass” has the same definition as that for “part by weight”.

Furthermore, in the present disclosure, a combination of two or more preferred aspects is a more preferred aspect.

In addition, the weight-average molecular weight (Mw) and the number-average molecular weight (Mn) in the present disclosure are molecular weights in terms of polystyrene used as a standard substance, which are detected by using a solvent tetrahydrofuran (THF), a differential refractometer, and a gel permeation chromatography (GPC) analyzer using TSKgel GMHxL, TSKgel G4000HxL, and TSKgel G2000HxL (all trade names manufactured by Tosoh Corporation) as columns, unless otherwise specified.

Hereinafter, the present disclosure will be described in detail.

(Method for Manufacturing Decorative Film for Molding)

The method for manufacturing a decorative film for molding according to the embodiment of the present disclosure includes, in the following order, a step of forming, on a base material, a liquid crystal layer including a cholesteric liquid crystal compound and a photoisomerization compound, a step of photoisomerizing the liquid crystal layer, and a step of curing the liquid crystal layer.

In addition, the decorative film for molding manufactured by the method for manufacturing a decorative film for molding according to the embodiment of the present disclosure can be used for various purposes, and examples thereof include interior and exterior of automobiles, interior and exterior of electric appliances, and packaging containers. The interior and exterior of electronic appliances are, for example, a decorative molded product of an electronic device, and examples thereof include use for decorating a housing panel of an electronic device such as a smartphone. Among these, the method for manufacturing a decorative film for molding according to the embodiment of the present disclosure is preferably a method for manufacturing a decorative film for molding, which is used for the interior and exterior of automobiles, or a decorative film for molding, which is used for decorating an electronic device, and is particularly preferably a method for manufacturing a decorative film for molding, which is used for the exterior of automobiles, or a decorative film for molding, which is used for decorating a housing panel of an electronic device.

As a result of intensive research conducted by the present inventors, it has been found that a decorative film for molding having a small change in reflectance after molding can be provided by employing the above-described configuration.

The mechanism of the excellent effects obtained by employing the above-described configuration is not clear, but is presumed as follows.

In the method for manufacturing a decorative film for molding according to the embodiment of the present disclosure, since a liquid crystal layer including a cholesteric liquid crystal compound and a photoisomerization compound is formed, and the photoisomerization compound is exposed to be isomerized, it is presumed that the length of the helical pitch of the cholesteric liquid crystalline phase formed by the cholesteric liquid crystal compound in the liquid crystal layer can be changed, and the maximum wavelength of the reflected light of the liquid crystal layer can be changed. In addition, it is presumed that, by correcting the difference in tint between a low-stretched portion and a high-stretched portion due to stretching during molding, a decorative film for molding having a small change in tint after molding can be obtained.

In addition, since the decorative film for molding includes the above-described liquid crystal layer, a color such as a structural color can be viewed, a change in color depending on the viewing angle and the viewed color itself can be adjusted, and the designability is also excellent.

Hereinafter, the method for manufacturing a decorative film for molding according to the embodiment of the present disclosure will be described in detail.

<Liquid Crystal Layer Forming Step>

The method for manufacturing a decorative film for molding according to the embodiment of the present disclosure includes a step (also referred to as a “liquid crystal layer forming step”) of forming, on a base material, a liquid crystal layer including a cholesteric liquid crystal compound and a photoisomerization compound.

In the formation of the liquid crystal layer, it is preferable to use a liquid crystal composition including a cholesteric liquid crystal compound and a photoisomerization compound, and it is more preferable to apply the liquid crystal composition to a base material.

The application of the above-described liquid crystal composition can be performed by a method of developing the polymerizable liquid crystal composition in a solution state with the solvent or in a liquid state, such as a molten liquid by heating, according to an appropriate method such as a roll coating method, a gravure printing method, and a spin coating method. Furthermore, the application of the above-described liquid crystal composition can be performed according to various methods such as a wire bar coating method, an extrusion coating method, a direct gravure coating method, a reverse gravure coating method, and a die-coating method. In addition, using an inkjet device, the above-described liquid crystal composition can be discharged from a nozzle to form a liquid crystal layer.

In a case of using the above-described solvent, it is preferable that the liquid crystal layer is dried by a known method. For example, the liquid crystal layer may be dried by allowing to stand or air-drying, or may be dried by heating.

The amount of the above-described liquid crystal composition to be applied may be appropriately set in consideration of the liquid crystal layer after drying.

In addition, it is preferable that the cholesteric liquid crystal compound in the above-described liquid crystal layer are aligned after the application and drying of the above-described liquid crystal composition.

From the viewpoint of designability, the decorative film for molding manufactured by the method for manufacturing a decorative film for molding according to the embodiment of the present disclosure is preferably a decorative film for viewing through the above-described liquid crystal layer, and more preferably a decorative film for viewing at least one of colored layers described later through the above-described liquid crystal layer.

In addition, it is not needed for the above-described liquid crystal layer to be in directly contact with the base material, and for example, the liquid crystal layer may be provided on the base material through another layer such as a colored layer described later.

Each layer configuration of the base material, the liquid crystal layer including a cholesteric liquid crystal compound and a photoisomerization compound, and the like will be described later.

<Photoisomerization Step>

The method for manufacturing a decorative film for molding according to the embodiment of the present disclosure includes a step (also referred to as a “photoisomerization step”) of photoisomerizing the liquid crystal layer.

The photoisomerization step is a step of photoisomerizing the photoisomerization compound included in the above-described liquid crystal layer.

In the photoisomerization step, from the viewpoint of suppressing change in reflectance after molding, it is preferable to isomerize the above-described liquid crystal layer so as to cause a difference in photoisomerization proportion for each region, and it is more preferable to isomerize the above-described liquid crystal layer so as to cause a difference in photoisomerization proportion for each region depending on the shape to be molded. Alternatively, a part of the above-described liquid crystal layer may be isomerized, or a part of the above-described liquid crystal layer may be isomerized depending on the shape to be molded.

In addition, in the photoisomerization step, the isomerization proportion of the above-described isomerization compound may be changed according to the shape to be molded. For example, a portion having an isomerization proportion of 0% and a portion having an isomerization proportion of 100% may be formed in the above-described liquid crystal layer, a portion where the isomerization proportion changes from 0% to 100% may be formed in the above-described liquid crystal layer, a portion having an isomerization proportion of 0% and a portion where the isomerization proportion changes from 50% to 100% may be formed in the above-described liquid crystal layer, or a portion having an isomerization proportion of 10% and a portion having an isomerization proportion of 80% may be formed in the above-described liquid crystal layer.

In particular, it is preferable that a portion where the stretch ratio of the decorative film for molding according to the embodiment of the present disclosure increases in a case of molding has a larger isomerization proportion according to the shape to be molded.

In addition, the progress of photoisomerization can be known by measuring the wavelength of maximum reflectance of the isomerized portion. The photoisomerization proportion represents a proportion of the number of photoisomerized photoisomerization compound molecules to the total number of molecules of the target photoisomerization compound, and similarly, the photoisomerization proportion can be determined by measuring the wavelength of maximum reflectance.

In the photoisomerization step, it is preferable to isomerize the above-described liquid crystal layer by changing the exposure intensity depending on the region. For example, the above-described liquid crystal layer may be isomerized by exposing the above-described liquid crystal layer with a plurality of steps of difference or a stepless continuous difference in exposure intensity, and it is preferable to isomerize the above-described liquid crystal layer by exposing only a part of the above-described liquid crystal layer. The isomerization proportion can also be controlled according to the exposure intensity.

The wavelength of light to be used for photoisomerization in the photoisomerization step is not particularly limited, and may be appropriately selected depending on the photoisomerization compound.

It is sufficient that the light to be used for exposure in the photoisomerization step is a light having a wavelength capable of photoisomerization, but it is preferable to photoisomerize the above-described liquid crystal layer using at least light in a wavelength range of 400 nm or less, it is more preferable to photoisomerize the above-described liquid crystal layer using at least light in a wavelength range of 360 nm or less, and it is particularly preferable to photoisomerize the above-described liquid crystal layer using at least light in a wavelength range of 310 nm to 360 nm.

A known unit and a known method can be used for adjusting the exposure wavelength in the photoisomerization step. Examples of the method include a method of using an optical filter, a method of using two or more types of optical filters, and a method of using a light source having a specific wavelength.

In the photoisomerization step, it is preferable to perform the above-described exposure with light in a wavelength range in which no polymerization initiating species are generated from the photopolymerization initiator described later. For example, a mask which transmits light in a wavelength range in which photoisomerization of the above-described isomerization compound occurs and blocks light in a wavelength range in which polymerization initiating species are generated from the photopolymerization initiator can be suitably used.

The mask is not particularly limited, and a known light-blocking unit such as a mask can be used.

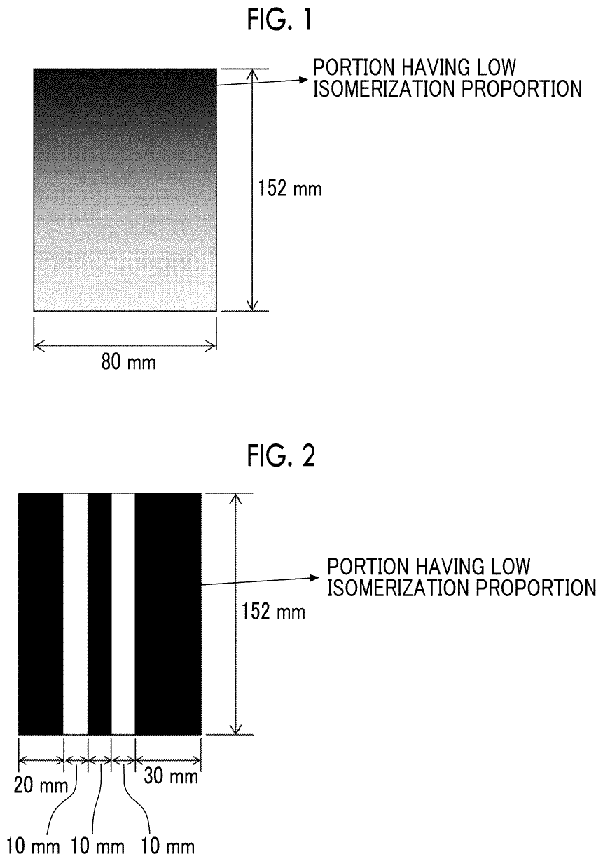

In addition, the mask may be used alone or in combination of two or more kinds thereof. For example, different masks may be used for the photoisomerized portion and the non-photoisomerized portion in the above-described liquid crystal layer, or in the photoisomerized portion of the above-described liquid crystal layer, a mask in which the amount of transmitted light is not constant and changes depending on the portion (for example, a mask having a mask pattern shown in FIGS. 1 and 2) may be used.

Specific examples of the light source include an ultra-high pressure mercury lamp, a high pressure mercury lamp, and a metal halide lamp. In addition, as the light source, a light emitting diode or the like capable of irradiating light having a narrow wavelength range can also be used. In this case, a mask may or may not be used as necessary.

The exposure amount in the photoisomerization step is not particularly limited and may be set appropriately, but is preferably 5 mJ/cm² to 2,000 mJ/cm² and more preferably 10 mJ/cm² to 1,000 mJ/cm². In addition, the exposure amount may be changed in each part of the above-described liquid crystal layer according to the desired isomerization proportion.

In addition, it is preferable to heat the above-described liquid crystal layer in a case of the above-described isomerization by exposure. The heating temperature is not particularly limited and may be selected according to the photoisomerization compound and the like to be used, and examples thereof include 60° C. to 120° C.

In addition, the exposure method is not particularly limited as long as the photoisomerization occurs, and for example, methods described in paragraphs 0035 to 0051 of JP2006-023696A can be suitably used in the present disclosure.

<Curing Step>

The method for manufacturing a decorative film for molding according to the embodiment of the present disclosure includes a step (also referred to as a “curing step”) of curing the liquid crystal layer.

In the curing step, the above-described liquid crystal layer is cured. By the curing, the alignment state of molecules of the above-described cholesteric liquid crystal compound is maintained and fixed, thereby forming a cholesteric liquid crystalline phase.

The curing is preferably performed by a polymerization reaction of polymerizable groups such as the ethylenic unsaturated group and the cyclic ether group in a compound included in the above-described liquid crystal layer.

In addition, the curing may be performed by exposure or by heat.

The curing is preferably performed by exposure. In a case where the curing is performed by exposure, it is preferable that the above-described liquid crystal layer includes a photopolymerization initiator.

A light source for exposure can be appropriately selected and used according to the photopolymerization initiator. Preferred examples thereof include a light source capable of irradiating light in a wavelength range (for example, 365 nm or 405 nm). Specific examples of the light source include an ultra-high pressure mercury lamp, a high pressure mercury lamp, and a metal halide lamp.

The exposure amount is not particularly limited and may be set appropriately, but is preferably 5 mJ/cm² to 2,000 mJ/cm² and more preferably 10 mJ/cm² to 1,000 mJ/cm².

In addition, it is preferable to heat the liquid crystal compound in order to facilitate the arrangement of the liquid crystal compound during the curing by the above-described exposure. The heating temperature is not particularly limited and may be selected according to composition of the liquid crystal layer to be cured, and examples thereof include 60° C. to 120° C.

In addition, not only the above-described liquid crystal layer is formed by the exposure, but also other layers such as the colored layer may also be cured by the exposure as necessary.

In addition, as the exposure method, for example, methods described in paragraphs 0035 to 0051 of JP2006-023696A can be suitably used in the present disclosure.

In addition, in a case where the above-described liquid crystal layer is cured by heat, the heating temperature and heating time are not particularly limited, and may be appropriately selected depending on a thermal polymerization initiator and the like to be used. For example, the heating temperature is preferably 60° C. to 200° C., and the heating time is preferably 1 minute to 2 hours. The heating unit is not particularly limited, and a known heating unit can be used. Examples thereof include a heater, an oven, a hot plate, an infrared lamp, and an infrared laser.

In addition, the oxygen concentration in the curing step is not limited, and the curing step may be performed in an oxygen atmosphere, in an atmosphere, or in a low oxygen atmosphere (preferably, in an atmosphere of an oxygen concentration of 1,000 ppm or less, that is, an atmosphere not including oxygen or including oxygen of more than 0 ppm and 1,000 ppm or less). In order to further promote the curing, the curing step is preferably performed in a low oxygen atmosphere, and more preferably performed under heating and in a low oxygen atmosphere.

<Other Steps>

The method for manufacturing a decorative film for molding according to the embodiment of the present disclosure may include other steps in addition to the above-described steps as desired.

Examples of other steps include a step of forming each layer described layer, specifically a step of forming a colored layer, a step of forming a protective layer, and a step of forming a pressure sensitive adhesive layer.

The formation of each of the above-described layers such as a colored layer can be performed by using the method described later or a known method.

˜Reflectance of Decorative Film for Molding˜

From the viewpoint of designability, the wavelength of maximum reflectance of the decorative film for molding manufactured by the method for manufacturing a decorative film for molding according to the embodiment of the present disclosure is preferably within a range of 380 nm to 780 nm. Therefore, it is preferable that the manufactured decorative film for molding includes a region where the wavelength of maximum reflectance is within a range of 380 nm to 780 nm. In the manufactured decorative film for molding, the region where the wavelength of maximum reflectance is within a range of 380 nm to 780 nm may be 50% to 100% of the area of the decorative film for molding, may be 80% to 100%, or may be 90% to 100%.

In addition, from the viewpoint of suppressing change in reflectance after molding, the difference in wavelength of a maximum reflectance between a region where the photoisomerization is most advanced in the decorative film for molding manufactured by the method for manufacturing a decorative film for molding according to the embodiment of the present disclosure, and a region where the photoisomerization is least advanced is preferably 50 nm or more, more preferably 75 nm or more, still more preferably 100 nm or more, and particularly preferably 200 nm to 1,000 nm.

For example, in a case where the decorative film for molding manufactured by the method for manufacturing a decorative film for molding according to the embodiment of the present disclosure has an isomerized portion and a non-isomerized portion, from the viewpoint of suppressing change in reflectance after molding, the difference in wavelength of a maximum reflectance between the isomerized portion and the non-isomerized portion is preferably 50 nm or more, more preferably 75 nm or more, still more preferably 100 nm or more, and particularly preferably 200 nm to 1,000 nm.

The above-described difference in wavelength of a maximum reflectance is preferably a difference in wavelength of a maximum reflectance in a range of 380 nm to 1,500 nm.

Furthermore, at least a part of a region of the decorative film for molding manufactured by the method for manufacturing a decorative film for molding according to the embodiment of the present disclosure may be stretched to a stretching ratio of 10% to 250% in terms of area ratio, and in this case, from the viewpoint of suppressing change in reflectance after molding, the difference in wavelength of a maximum reflectance between a stretched region and a region where the photoisomerization is least advanced is preferably less than 50 nm, more preferably 40 nm or less, and particularly preferably 20 nm or less. In addition, the lower limit value of the difference in wavelength of a maximum reflectance between the stretched region and the region where the photoisomerization is least advanced is 0 nm.

In one embodiment in which an isomerized portion and a non-isomerized portion are provided, the isomerized portion of the decorative film for molding manufactured by the method for manufacturing a decorative film for molding according to the embodiment of the present disclosure may be stretched to a value of one stretching ratio within a range of 10% to 250% in terms of area ratio, and in this case, from the viewpoint of suppressing change in reflectance after molding, the difference in wavelength of a maximum reflectance of the isomerized portion and the non-isomerized portion is preferably less than 50 nm, more preferably 40 nm or less, and particularly preferably 20 nm or less. In addition, the lower limit value of the difference in wavelength of a maximum reflectance between the stretched region and the above-described non-isomerized portion is 0 nm.

The stretching ratio of the above-described stretched portion is preferably 20% to 250% and more preferably 70% to 220%.

The method for measuring the reflectance of the decorative film for molding according to the embodiment of the present disclosure is a method in which a black polyethylene terephthalate (PET) film (manufactured by TOMOEGAWA CO., LTD., product name: “KUKKIRI MIERU”) is attached to the outermost layer of the decorative film for molding on a side opposite to the viewing side, and the reflection spectrum is measured using a spectrophotometer V-670 manufactured by JASCO Corporation, with a surface on which the liquid crystal layer is formed as an incident surface.

Hereinafter, each layer such as the base material and the liquid crystal layer will be described in detail.

<<Base Material>>

As the base material used in the present disclosure, a known base material in the related art, as a base material used for molding such as three-dimensional molding and insert molding, can be used without particular limitation and may be appropriately selected depending on the application of the decorative film, suitability for insert molding, and the like.

In addition, the shape and material of the base material are not particularly limited and may be appropriately selected as desired, but from the viewpoint of ease of insert molding and chipping resistance, a resin base material is preferable, and a resin film base material is preferable.

Specific examples of the base material include a resin film including a resin such as a polyethylene terephthalate (PET) resin, a polyethylene naphthalate (PEN) resin, an acrylic resin, a urethane resin, a urethane-acrylic resin, a polycarbonate (PC) resin, an acrylic-polycarbonate resin, triacetyl cellulose (TAC), cycloolefin polymer (COP), and acrylonitrile/butadiene/styrene copolymer resin (ABS resin).

Among these, from the viewpoint of moldability and strength, at least one resin film selected from the group consisting of a PET resin, an acrylic resin, a urethane resin, a urethane-acrylic resin, a PC resin, an acrylic-polycarbonate resin, and a polypropylene resin is preferable, and at least one resin film selected from the group consisting of an acrylic resin, a PC resin, and an acrylic-polycarbonate resin is more preferable.

In addition, the base material may be a laminated resin base material having two or more layers. Preferred examples thereof include an acrylic resin/polycarbonate resin laminated film.

The base material may contain other additives as necessary.

Examples of such additives include lubricants such as mineral oil, hydrocarbons, fatty acids, alcohols, fatty acid esters, fatty acid amides, metallic soaps, natural waxes, and silicone; inorganic flame retardants such as magnesium hydroxide and aluminum hydroxide; organic flame retardants such as a halogen-based flame retardant and a phosphorus-based flame retardant; organic or inorganic fillers such as metal powder, talc, calcium carbonate, potassium titanate, glass fibers, carbon fibers, and wood powder; additives such as an antioxidant, a UV inhibitor, a lubricant, a dispersant, a coupling agent, a foaming agent, and a colorant; and engineering plastics other than the above-described resins, such as a polyolefin resin, a polyester resin, a polyacetal resin, a polyamide resin, and a polyphenylene ether resin.

As the base material, a commercially available product may be used.

Examples of the commercially available product include TECHNOLLOY (registered trademark) series (acrylic resin film or acrylic resin/polycarbonate resin laminated film, manufactured by Sumitomo Chemical Co., Ltd.), ABS films (manufactured by Okamoto Industries, Inc.), ABS sheets (manufactured by SEKISUI SEIKEI CO., LTD.), Teflex (registered trademark) series (PET film, manufactured by TEIJIN FILM SOLUTIONS LIMITED), Lumirror (registered trademark) easily moldable type (PET film, manufactured by TORAY INDUSTRIES, INC), and Purethermo (polypropylene film, manufactured by Idemitsu Kosan Co., Ltd.).

The thickness of the base material is determined depending on the application of the produced molded product, handleability of the sheet, and the like, which is not particularly limited, but is preferably 1μm or more, more preferably 10 μm or more, still more preferably 20 μm or more, and particularly preferably 50 μm or more. The upper limit of the thickness of the base material is preferably 500 μm or less, more preferably 450 μm or less, and particularly preferably 200 μm or less.

<<Liquid Crystal Layer>>

In the above-described liquid crystal layer forming step, a liquid crystal layer including a cholesteric liquid crystal compound and a photoisomerization compound is formed on the base material.

In the liquid crystal layer, by changing at least one selected from the group consisting of the pitch of a helical structure, refractive index, and thickness of the liquid crystal layer, it is possible to adjust the change in color according to the viewed angle, and the viewed color itself. The pitch of the helical structure can be easily adjusted by changing the addition amount of a chiral agent. More specifically, detailed description can be found in FUJIFILM Research Report No. 50 (2005), pp. 60 to 63. In addition, the pitch of the helical structure can also be adjusted by conditions such as temperature, illuminance, and irradiation time in a case of fixing cholesteric alignment state.

In addition, a cured liquid crystal layer after the curing step described later is preferably a liquid crystal layer in which the cholesteric liquid crystal compound is fixed in a cholesteric alignment state. The cholesteric alignment state may be an alignment state reflecting right-handed circular polarization, may be an alignment state reflecting left-handed circular polarization, or may include both alignment states. The cholesteric liquid crystal compound is not particularly limited, and various known cholesteric liquid crystal compounds can be used.

—Cholesteric Liquid Crystal Compound—The liquid crystal layer in the above-described liquid crystal layer forming step includes a cholesteric liquid crystal compound.

Examples of the cholesteric liquid crystal compound include a rod-like type and a disk-like type depending on the shape of the cholesteric liquid crystal compound. Each of the types can further be classified into a low-molecular-weight type and a high-molecular-weight type. In the present disclosure, a high molecule in the above-described cholesteric liquid crystal compound generally refers to a molecule having a polymerization degree of 100 or more (Masao Doi; Polymer Physics-Phase Transition Dynamics, 1992, IWANAMI SHOTEN, PUBLISHERS, page 2).

In the present disclosure, any cholesteric liquid crystal compound can be used, but it is preferable to use a rod-like cholesteric liquid crystal compound.

In the present specification, in a case of describing a layer formed from a composition including the cholesteric liquid crystal compound, the formed layer may not include a compound having crystallinity. For example, the formed layer may be a layer that includes a low-molecular-weight cholesteric liquid crystal compound having a group reacting by heat, light, and the like, in which the group reacting by heat, light, and the like reacts by heat, light, and the like to polymerize or crosslink the low-molecular-weight cholesteric liquid crystal compound, and the molecular weight is increased, resulting in loss of crystallinity.

In addition, as the cholesteric liquid crystal compound, a mixture of two or more kinds of rod-like cholesteric liquid crystal compounds, two or more kinds of disk-like liquid crystal compounds, or rod-like cholesteric liquid crystal compound and disk-like cholesteric liquid crystal compound may be used. Since changes in temperature and humidity can be reduced, as the cholesteric liquid crystal compound, it is more preferable to use a rod-like cholesteric liquid crystal compound or disk-like cholesteric liquid crystal compound having a reactive group, and it is still more preferable that at least one of these cholesteric liquid crystal compounds has two or more reactive groups in one liquid crystal molecule. In a case of a mixture of two or more cholesteric liquid crystal compounds, it is preferable that at least one thereof has two or more reactive groups.

In addition, it is preferable to use a cholesteric liquid crystal compound having two or more reactive groups having different crosslinking mechanisms. In a case of using the above-described compound, it is preferable that, by polymerizing only a part of the two or more reactive groups by selecting conditions, an optically anisotropic layer including a polymer having an unreacted reactive group is produced.

The crosslinking mechanism is not particularly limited such as condensation reaction, hydrogen bond, and polymerization, but in a case where two or more reactive groups are present, it is preferable that at least one of two or more crosslinking mechanisms used is polymerization, and it is more preferable to use two or more different polymerization reactions. In the crosslinking reaction in the above-described crosslinking, not only a vinyl group, a (meth)acrylic group, an epoxy group, an oxetanyl group, or a vinyl ether group is used for polymerization, but also a hydroxy group, a carboxy group, an amino group, or the like can be used.

The compound having two or more reactive groups having different crosslinking mechanisms in the present disclosure is a compound which can be crosslinked stepwise using different crosslinking reaction steps, and in the crosslinking reaction step of each step, the reactive group corresponding to each crosslinking mechanism reacts as a functional group. For example, in a case of a polymer such as polyvinyl alcohol, which has a hydroxy group in the side chain, and a case where the hydroxy group of the side chain is crosslinked with an aldehyde or the like after a polymerization reaction to polymerize the polymer, the case means that two or more different crosslinking mechanisms are used. However, in the present disclosure, it is preferable that the case of the compound having two or more different reactive groups means a compound having two or more different reactive groups in a layer immediately before a timing of forming the layer on a support or the like, and means a compound capable of subsequently crosslinking the reactive groups stepwise.

In addition, as the reactive group, a polymerizable group is preferable. Examples of the polymerizable group include radically polymerizable group and cationically polymerizable group.

Among these, it is particularly preferable to use a cholesteric liquid crystal compound having two or more polymerizable groups.

The distinction of reaction conditions for stepwise crosslinking may be a distinction of temperature, a distinction of wavelength of light (irradiation ray), or a distinction of polymerization mechanism, but from the viewpoint the reaction can be easily separated, it is preferable to use a distinction of polymerization mechanism, and it is more preferable to control the reaction by the type of the polymerization initiator used.

As a combination of the polymerizable groups, a combination of a radically polymerizable group and a cationically polymerizable group is preferable. Among these, a combination in which the above-described radically polymerizable group is a vinyl group or a (meth)acrylic group and the above-described cationically polymerizable group is an epoxy group, an oxetanyl group, or a vinyl ether group is particularly preferable because the reactivity can be easily controlled.

Among these, from the viewpoint of reactivity and ease of fixing the pitch of the helical structure, the cholesteric liquid crystal compound preferably has a radically polymerizable group.

Examples of the reactive group are shown below. Et represents an ethyl group and n-Pr represents an n-propyl group.

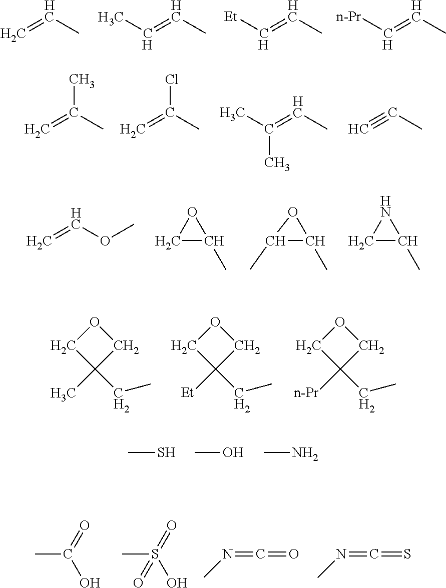

Preferred examples of the rod-like cholesteric liquid crystal compound include azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles. In addition to the above-described low-molecular weight cholesteric liquid crystal compounds, a high-molecular-weight cholesteric liquid crystal compound can also be used. The above-described high-molecular-weight cholesteric liquid crystal compound is a polymer compound obtained by polymerizing a rod-like cholesteric liquid crystal compound having a low molecular weight and a reactive group. Examples of the rod-like cholesteric liquid crystal compound include compounds described in JP2008-281989A, JPJP1999-513019A (JP-H11-513019A) (WO1997/000600A1), or JP2006-526165A.

Specific examples of the rod-like cholesteric liquid crystal compound are shown below, but the rod-like cholesteric liquid crystal compound is not limited thereto. The compounds shown below can be synthesized by the method described in JP1999-513019A (JP-H11-513019A) (WO1997/000600A1).

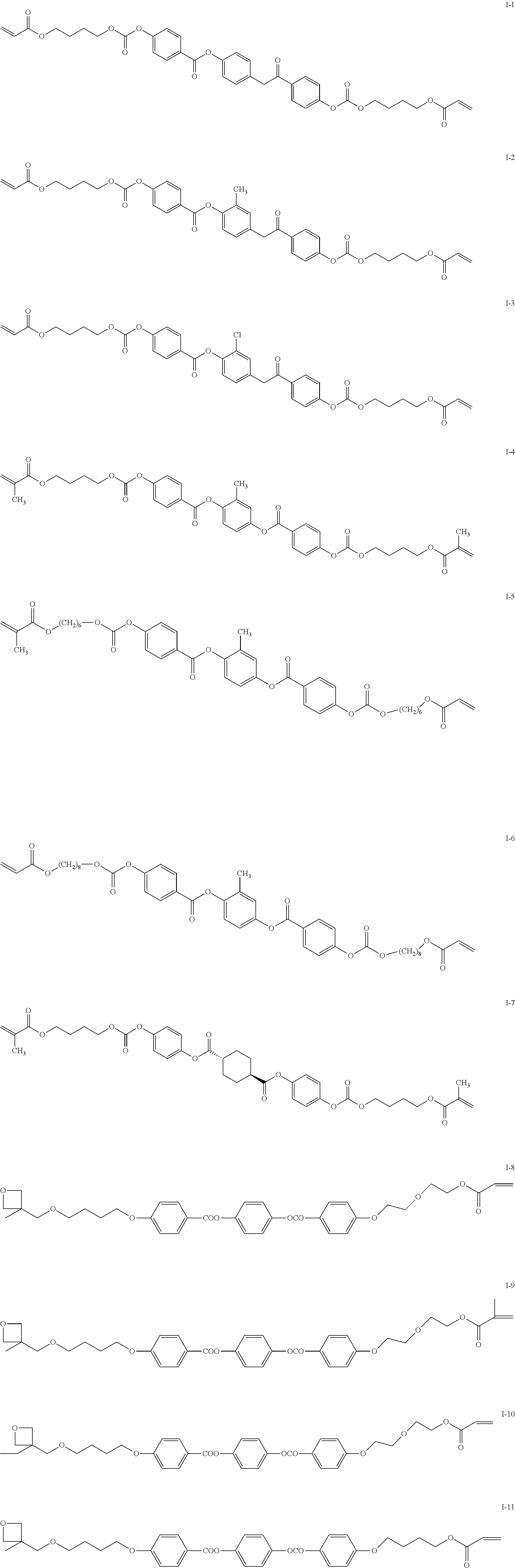

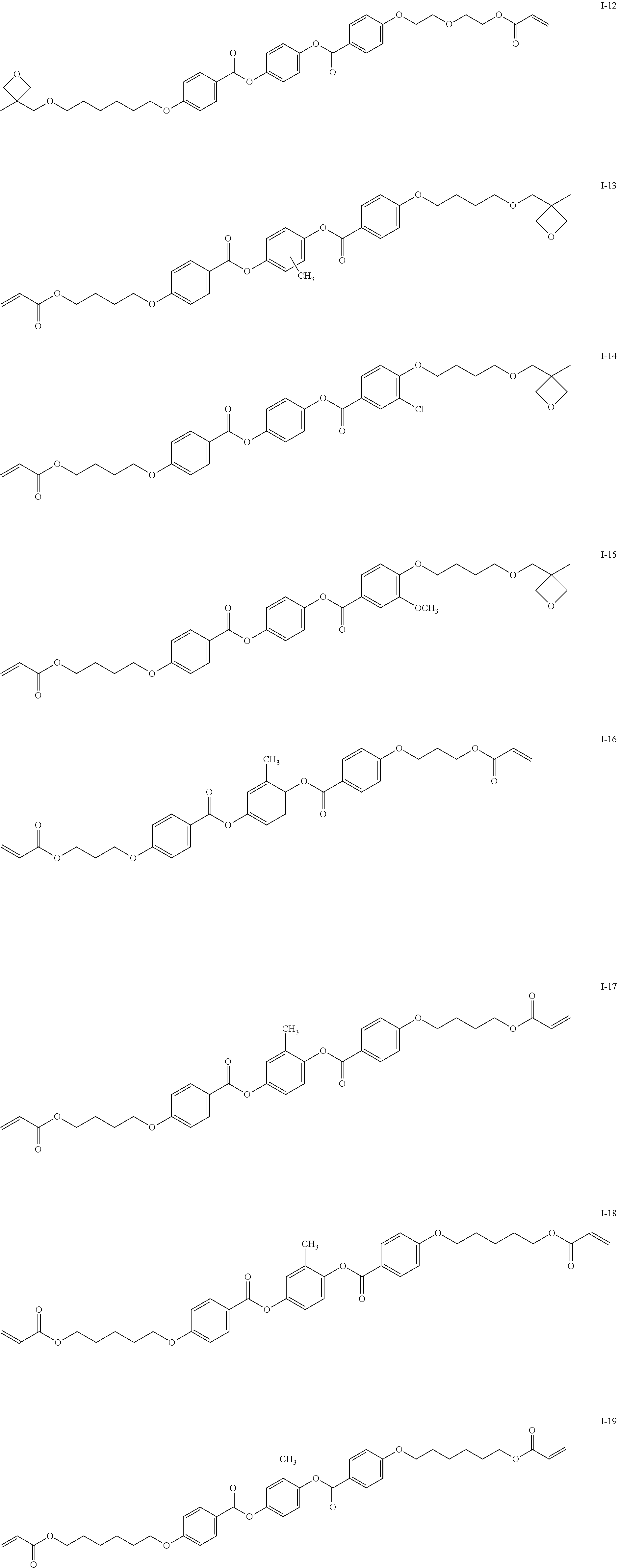

Examples of the disk-like cholesteric liquid crystal compound include low-molecular-weight disk-like cholesteric liquid crystal compounds such as a monomer, and polymerizable disk-like cholesteric liquid crystal compounds.

Examples of the disk-like cholesteric liquid crystal compound include benzene derivatives described in C. Destrade et. al.'s study report, “Mol. Cryst.”, vol. 71, page 111 (1981); truxene derivatives described in C. Destrade et. al.'s study report, “Mol. Cryst.”, vol. 122, page 141 (1985) and “Physics lett, A”, vol. 78, page 82 (1990); cyclohexane derivatives described in B. Kohne et. al.'s study report, “Angew. Chem.”, vol. 96, page 70 (1984); and azacrown-based or phenyl acetylene-based macrocycles described in J. M. Lehn et. al.'s study report, “J. Chem. Commun.”, page 1794 (1985) and J. Zhang et. al.'s study report, “J. Am. Chem. Soc.”, vol. 116, page 2655 (1994).

The above-described disk-like cholesteric liquid crystal compound includes a liquid crystal compound, generally called a disk-like liquid crystal, which has the above-described various structures as a disk-like mother nucleus at the center of the molecule, has a structure in which groups (L) such as a linear alkyl group, alkoxy group, and a substituted benzoyloxy group are radially substituted, and exhibits crystallinity. In a case where such an aggregate of molecules is uniformly aligned, the aggregate exhibits negative uniaxiality, but the disk-like cholesteric compound is not limited to this description. Examples of the disk-like cholesteric liquid crystal compound include compounds described in paragraphs 0061 to 0075 of JP2008-281989A.

In a case where a disk-like cholesteric liquid crystal compound having a reactive group is used as the cholesteric liquid crystal compound, in the cured liquid crystal layer described later, the disk-like cholesteric liquid crystal compound having a reactive group may be fixed in any alignment state of horizontal alignment, homeotropic alignment, tilt alignment, or twist alignment.

In the liquid crystal layer including the cholesteric liquid crystal compound, a polymerizable monomer may be added in order to promote crosslinking of the cholesteric liquid crystal compound.

For example, a monomer or oligomer having two or more ethylenic unsaturated bonds and addition-polymerizing by irradiation with light can be used as the polymerizable monomer.

Examples of such a monomer or oligomer include compounds having at least one addition-polymerizable ethylenic unsaturated group in the molecule. Examples thereof include monofunctional acrylates or monofunctional methacrylates, such as polyethylene glycol mono(meth)acrylate, polypropylene glycol mono(meth)acrylate, and phenoxyethyl (meth)acrylate; polyethylene glycol di(meta)acrylate, polypropylene glycol di(meta)acrylate, trimethylol ethane triacrylate, trimethylol propane tri(meta)acrylate, trimethylol propane diacrylate, neopentyl glycol di(meta)acrylate, pentaerythritol tetra(meta)acrylate, pentaerythritol tri(meta)acrylate, dipentaerythritol hexa(meta)acrylate, dipentaerythritol penta(meta)acrylate, hexanediol di(meta)acrylate, trimethylol propane tri(acryloyloxypropyl)ether, tri(acryloyloxyethyl) isocyanurate, tri(acryloyloxyethyl) cyanurate, and glycerin tri(meth)acrylate; and polyfunctional acrylates or polyfunctional methacrylates, such as those obtained by adding ethylene oxide or propylene oxide to polyfunctional alcohols such as trimethylpropane and glycerin and then being (meth)acrylated.

Furthermore, examples thereof include polyfunctional acrylates or methacrylates such as urethane acrylates described in JP1973-041708B (JP-S48-041708B), JP1975-006034B (JP-S50-006034B), and JP1976-037193A (JP-S51-037193A); polyester acrylates described in JP1973-064183B (JP-S48-064183B), JP1974-043191B (JP-S49-043191B), and JP1977-030490B (JP-S52-030490B); and epoxy acrylates which are reaction products of epoxy resin and (meth)acrylic acid.

Among these, trimethylol propane tri(meta)acrylate, pentaerythritol tetra(meth)acrylate, dipentaerythritol hexa(meth)acrylate, or dipentaerythritol penta(meth)acryl ate is preferable.

In addition, the “polymerizable compound B” described in JP1999-133600A (JP-H11-133600A) can also be exemplified as a suitable compound.

These monomers or oligomers may be used alone or in a mixture of two or more thereof

In addition, a cationically polymerizable monomer can also be used. Examples thereof include epoxy compounds, vinyl ether compounds, and oxetane compounds, which are exemplified in JP1994-009714A (JP-H06-009714A), JP2001-031892A, JP2001-040068A, JP2001-055507A, JP2001-310938A, JP2001-310937A, and JP2001-220526A.

Examples of the epoxy compound include the following aromatic epoxides, alicyclic epoxides, and aliphatic epoxides.

Examples of the aromatic epoxide include di or polyglycidyl ethers of bisphenol A or an alkylene oxide adduct of bisphenol A, di or polyglycidyl ethers of hydrogenated bisphenol A or an alkylene oxide adduct of hydrogenated bisphenol A, and novolak-type epoxy resin. Here, examples of the alkylene oxide include ethylene oxide and propylene oxide.

Examples of the alicyclic epoxide include cyclohexene oxide or cyclopentene oxide-containing compounds, which are obtained by epoxidizing a compound having at least one cycloalkane ring such as a cyclohexene ring and a cyclopentene ring with an appropriate oxidizing agent such as hydrogen peroxide and peroxy acid.

Preferred aliphatic epoxides include aliphatic polyhydric alcohols or di or polyglycidyl ethers of an alkylene oxide adduct of polyhydric alcohol, and typical examples thereof include diglycidyl ethers of alkylene glycol, such as diglycidyl ether of ethylene glycol, diglycidyl ether of propylene glycol, and diglycidyl ether of 1,6-hexanediol; polyglycidyl ethers of polyhydric alcohol, such as di or triglycidyl ether of glycerin or an alkylene oxide adduct of glycerin; and diglycidyl ethers of polyalkylene glycol, such as diglycidyl ether of polyethylene glycol or an alkylene oxide adduct of polyethylene glycol, and diglycidyl ether of polypropylene glycol or an alkylene oxide adduct of polypropylene glycol. Here, examples of the alkylene oxide include ethylene oxide and propylene oxide.

In addition, as the cationically polymerizable monomer, a monofunctional or bifunctional oxetane monomer can also be used. For example, 3-ethyl-3-hydroxymethyloxetane (such as product name OXT 101 manufactured by TOAGOSEI CO., LTD.), 1,4-bis[(3-ethyl-3-oxetanyl)methoxymethyl]benzene (such as OXT 121), 3-ethyl-3-(phenoxymethyl)oxetane (such as OXT 211), di(1-ethyl-3-oxetanyl)methyl ether (such as OXT 221), 3-ethyl-3-(2-ethylhexyloxymethyl)oxetane (such as OXT 212), or the like can be preferably used. In particular, compounds such as 3-ethyl-3-hydroxymethyloxetane, 3-ethyl-3-(phenoxymethyl)oxetane, di(1-ethyl-3-oxetanyl)methyl ether, and any known monofunctional or polyfunctional oxetane compound described in JP2001-220526A and JP2001-310937A can be used.

In a case where two or more optically anisotropic layers formed of a composition including the cholesteric liquid crystal compound are laminated, the combination of liquid crystal compounds is not particularly limited. The above-described combination may be a laminate of layers in which all cholesteric liquid crystal compounds are rod-like cholesteric liquid crystal compounds, a laminate of a layer including a disk-like cholesteric liquid crystal compound as the cholesteric liquid crystal compound and a layer including a rod-like cholesteric liquid crystal compound as the cholesteric liquid crystal compound, or a laminate layers in which all cholesteric liquid crystal compounds are disk-like cholesteric liquid crystal compounds. In addition, the combination of the alignment states of each layer is also not particularly limited, and the cured liquid crystal layers having the same alignment state may be laminated, or the cured liquid crystal layers having different alignment states may be laminated.

The above-described liquid crystal layer may include one cholesteric liquid crystal compound alone, or may include two or more cholesteric liquid crystal compounds.

From the viewpoint of designability, the content of the cholesteric liquid crystal compound is preferably 30% by mass to 99% by mass, more preferably 40% by mass to 99% by mass, still more preferably 60% by mass to 99% by mass, and particularly preferably 70% by mass to 98% by mass with respect to the total mass of the above-described liquid crystal layer.

—Crosslinking Density in Cured Liquid Crystal Layer of Decorative Film for Molding—

In a case where a cholesteric liquid crystal compound having a radically polymerizable group is used in the above-described liquid crystal layer, from the viewpoint of fixing the liquid crystal alignment, three-dimensional moldability, and suppressing change in reflectance after molding, the crosslinking density of the above-described radically polymerizable group in the cured liquid crystal layer in the decorative film for molding manufactured by the method for manufacturing a decorative film for molding according to the embodiment of the present disclosure is preferably 0.05 mol/L to 1 mol/L, more preferably 0.1 mol/L to 0.5 mol/L, still more preferably 0.15 mol/L to 0.45 mol/L, and particularly preferably 0.2 mol/L to 0.4 mol/L.

As a method for measuring the crosslinking density, FT/IR-4000 manufactured by JASCO Corporation is used, and the measurement is performed as follows.

A liquid crystal layer is formed on a silicon wafer SiD-4 manufactured by Canosis Co., Ltd.

The reaction consumption rate of C═C double bond (ethylenic unsaturated bond) is estimated by the following expression, and the equivalent amount (mol/L) of the C═C double bond included in the liquid crystal layer is calculated from the amount of the formulation added and multiplied by the reaction consumption rate. The result is defined as the crosslinking density of the radically polymerizable group in the cured liquid crystal layer.

Reaction consumption rate =(peak intensity derived from C═C double bond before curing—peak intensity derived from C═C double bond after curing) / peak intensity derived from C═C double bond before curing

—Photoisomerization Compound—

The liquid crystal layer in the above-described liquid crystal layer forming step includes a photoisomerization compound.

The photoisomerization compound may be a compound capable of photoisomerization, but from the viewpoint of suppressing change in reflectance after molding and maintaining the isomerized structure, the photoisomerization compound is preferably a compound in which a three-dimensional structure changes with exposure.

In the above-described photoisomerization step, the photoisomerization structure of the above-described photoisomerization compound to be photoisomerized is not particularly limited, but from the viewpoint of suppressing change in reflectance after molding, ease of photoisomerization, and maintaining the isomerized structure, it is preferable to be a structure in which a three-dimensional structure changes with exposure, it is more preferable to have a di or higher-substituted ethylenic unsaturated bond in which an EZ configuration is isomerized by exposure, and it is particularly preferable to have a di-substituted ethylenic unsaturated bond in which an EZ configuration is isomerized by exposure.

In addition, the isomerization of the EZ configuration in the present disclosure also includes cis-trans isomerization.

In addition, the above-described di-substituted ethylenic unsaturated bond is preferably an ethylenic unsaturated bond in which an aromatic group and an ester bond are substituted.

In addition, the photoisomerization compound may have only one photoisomerization structure or may have two or more photoisomerization structures, but from the viewpoint of suppressing change in reflectance after molding, ease of photoisomerization, and maintaining the isomerized structure, it is preferable to have two or more photoisomerization structures, it is more preferable to have two to four photoisomerization structures, and it is particularly preferable to have two photoisomerization structures.

The above-described photoisomerization compound is preferably a photoisomerization compound which also acts as a chiral agent described later.

The above-described photoisomerization compound which also acts as a chiral agent is preferably a chiral agent having a molar light absorption coefficient of 30,000 or more at a wavelength of 313 nm.

In addition, preferred examples of the above-described photoisomerization compound which also acts as a chiral agent include a compound represented by Formula (CH1).

The compound represented by Formula (CH1) can change the alignment structure such as the helical pitch (twisting force and helical twist angle) of a cholesteric liquid crystalline phase according to the amount of light during irradiation with light.

In addition, the compound represented by Formula (CH1) is a compound in which the EZ configuration in the two ethylenic unsaturated bonds can be isomerized by exposure.

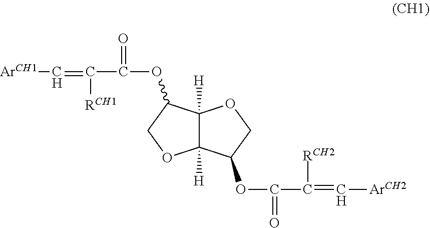

In Formula (CH1), Ar^{CH1} and Ar^{CH2} each independently represent an aryl group or a heteroaromatic ring group, and R^{CH1} and R^{CH2} each independently represent a hydrogen atom or a cyano group.

In Formula (CH1), it is preferable that Ar^{CH1} and Ar^{CH2} are each independently an aryl group.

The aryl group of Ar^{CH1} and Ar^{CH2} in Formula (CH1) may have a substituent, and the aryl group thereof preferably has a total carbon number of 6 to 40, and more preferably has a total carbon number of 6 to 30. As the substituent, for example, a halogen atom, an alkyl group, an alkenyl group, an alkynyl group, an alkoxy group, a hydroxy group, an acyl group, an alkoxycarbonyl group, an aryloxycarbonyl group, an acyloxy group, a carboxy group, a cyano group, or a heterocyclic group is preferable, and a halogen atom, an alkyl group, an alkenyl group, an alkoxy group, a hydroxy group, an acyloxy group, an alkoxycarbonyl group, or an aryloxycarbonyl group is more preferable.

In Formula (CH1), it is preferable that R^{CH1} and R^{CH2} are each independently a hydrogen atom.

Among these, as Ar^{CH1} and Ar^{CH2}, an aryl group represented by Formula (CH2) or Formula (CH3) is preferable.

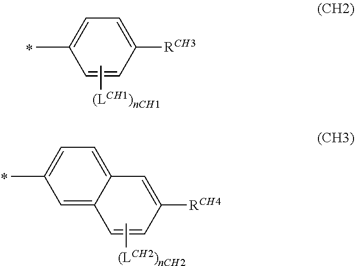

In Formula (CH2) and Formula (CH3), R^{CH3} and R^{CH4} each independently represent a hydrogen atom, a halogen atom, an alkyl group, an alkenyl group, an alkynyl group, an aryl group, a heterocyclic group, an alkoxy group, a hydroxy group, an acyl group, an alkoxycarbonyl group, an aryloxycarbonyl group, an acyloxy group, a carboxy group, or a cyano group, L^{CH1} and L^{CH2} each independently represent a halogen atom, an alkyl group, an alkoxy group, or a hydroxy group, nCH1 represents an integer of 0 to 4, nCH2 represents an integer of 0 to 6, and * represents a bonding position with the ethylenic unsaturated bond in Formula (CH1).

In Formula (CH2) and Formula (CH3), R^{CH3} and R^{CH4} are each independently preferably a hydrogen atom, a halogen atom, an alkyl group, an alkenyl group, an aryl group, an alkoxy group, a hydroxy group, an alkoxycarbonyl group, an aryloxycarbonyl group, or an acyloxy group, more preferably an alkoxy group, a hydroxy group, or an acyloxy group, and particularly preferably an alkoxy group.

In Formula (CH2) and Formula (CH3), L^{CH1} and L^{CH2} are each independently preferably an alkoxy group having 1 to 10 carbon atoms, or a hydroxy group.

nCH1 in Formula (CH2) is preferably 0 or 1.

nCH2 in Formula (CH3) is preferably 0 or 1.

The heteroaromatic ring group of Ar^{CH1} and Ar^{CH2} in Formula (CH1) may have a substituent, and the heteroaromatic ring group thereof preferably has a total carbon number of 4 to 40, and more preferably has a total carbon number of 4 to 30. As the substituent, for example, a halogen atom, an alkyl group, an alkenyl group, an alkynyl group, an aryl group, an alkoxy group, a hydroxy group, an acyl group, an alkoxycarbonyl group, an aryloxycarbonyl group, an acyloxy group, or a cyano group is preferable, and a halogen atom, an alkyl group, an alkenyl group, an aryl group, an alkoxy group, or an acyloxy group is more preferable.

As the heteroaromatic ring group, a pyridyl group, a pyrimidinyl group, a furyl group, or a benzofuranyl group is preferable, and a pyridyl group or a pyrimidinyl group is more preferable.

Preferred examples of the above-described photoisomerization compound include the following compounds. Bu represents an n-butyl group.

The following compounds are compounds in which the steric configuration of each ethylenic unsaturated bond is E-form (trans-form), but changes to Z-form (cis-form) by exposure.

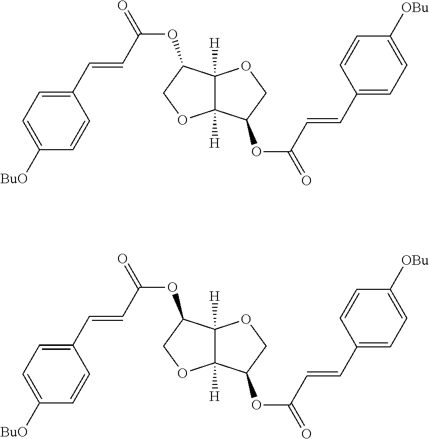

The above-described liquid crystal layer may include one photoisomerization compound alone, or may include two or more photoisomerization compounds.

From the viewpoint of suppressing change in reflectance after molding, the content of the photoisomerization compound is preferably 1% by mass to 20% by mass, more preferably 2% by mass to 10% by mass, still more preferably 3% by mass to 9% by mass, and particularly preferably 4% by mass to 8% by mass with respect to the total mass of the above-described liquid crystal layer.

—Chiral Agent (Optically Active Compound)—

From the viewpoint of ease of forming a liquid crystal layer and ease of adjusting the pitch of the helical structure, the above-described liquid crystal layer preferably includes a chiral agent (optically active compound).

The chiral agent has a function of inducing a helical structure in the liquid crystal layer.

The chiral agent has a function of inducing a helical structure in the cholesteric liquid crystalline phase. Since the sense or helical pitch of the helix induced by the chiral agent is different depending on a compound, the chiral compound may be selected according to the purpose.

As the chiral agent, a known compound can be used, but it is preferable to have a cinnamoyl group. Examples of the chiral agent include compounds described in Liquid Crystal Device Handbook, Chapter 3 articles 4-3, TN, chiral agent for STN, page 199, Japan Society for the Promotion of Science No. 142 committee version, 1989, and JP2003-287623A, JP2002-302487A, JP2002-080478A, JP2002-080851A, JP2010-181852A, and JP2014-034581A.

The chiral agent preferably includes an asymmetric carbon atom, but an axially asymmetric compound or a surface asymmetric compound, which does not have the asymmetric carbon atom, can also be used as the chiral agent. Examples of the axially asymmetric compound or the surface asymmetric compound include binaphthyl, helicene, paracyclophane, and derivatives thereof.

In addition, the chiral agent may include a polymerizable group.

In a case where both the chiral agent and the cholesteric liquid crystal compound have a polymerizable group, by a polymerization reaction between the chiral agent (polymerizable chiral agent) having a polymerizable group and the cholesteric liquid crystal compound (polymerizable cholesteric liquid crystal compound) having a polymerizable group, a polymer having a structural unit derived from the polymerizable cholesteric liquid crystal compound, and a structural unit derived from the chiral agent can be formed.

In this aspect, the polymerizable group of the polymerizable chiral agent is preferably the same polymerizable group as the polymerizable group of the polymerizable cholesteric liquid crystal compound.

The polymerizable group of the chiral agent is preferably an ethylenic unsaturated group, an epoxy group, or an aziridinyl group, more preferably an ethylenic unsaturated group, and particularly preferably an ethylenic unsaturated polymerizable group.

In addition, the chiral agent may be a cholesteric liquid crystal compound.

Among these, from the viewpoint of ease of forming a liquid crystal layer and ease of adjusting the pitch of the helical structure, and viewpoint of suppressing change in reflectance after molding, as the chiral agent, the above-described liquid crystal layer preferably includes at least one photoisomerization compound which also acts as the chiral agent, and more preferably includes at least one compound represented by Formula (CH1).

As the chiral agent, an isosorbide derivative, an isomannide derivative, a binaphthyl derivative, or the like can be preferably used. As the isosorbide derivative, a commercially available product such as LC-756 manufactured by BASF may be used.

The above-described liquid crystal layer may include one chiral agent alone, or may include two or more chiral agents.

The content of the chiral agent can be appropriately selected according to the desired pitch of the structure and helical structure of the cholesteric liquid crystal compound to be used. However, from the viewpoint of ease of forming a liquid crystal layer and ease of adjusting the pitch of the helical structure, and viewpoint of suppressing change in reflectance after molding, the content of the chiral agent is preferably 1% by mass to 20% by mass, more preferably 2% by mass to 10% by mass, still more preferably 3% by mass to 9% by mass, and particularly preferably 4% by mass to 8% by mass with respect to the total mass of the above-described liquid crystal layer.

In addition, from the viewpoint of suppressing change in reflectance after molding, the content of the chiral agent having a polymerizable group is preferably 0.2% by mass to 15% by mass, more preferably 0.5% by mass to 10% by mass, still more preferably 1% by mass to 8% by mass, and particularly preferably 1.5% by mass to 5% by mass with respect to the total mass of the above-described liquid crystal layer.

Furthermore, in a case of containing a chiral agent not having a polymerizable group, from the viewpoint of suppressing change in reflectance after molding, the content of the chiral agent not having a polymerizable group is preferably 0.2% by mass to 20% by mass, more preferably 0.5% by mass to 10% by mass, and particularly preferably 2% by mass to 8% by mass with respect to the total mass of the above-described liquid crystal layer.

In addition, the pitch of the helical structure of the cholesteric liquid crystal in the liquid crystal layer, and the selective reflection wavelength and its range described later can be easily adjusted by changed not only by adjusting the type of the cholesteric liquid crystal compound used but also by adjusting the content of the chiral agent. Although it cannot be said unconditionally, in a case where the content of the chiral agent in the liquid crystal layer is doubled, the above-described pitch may be halved and the center value of the above-described selective reflection wavelength may be halved.

—Polymerization Initiator—

The above-described liquid crystal layer preferably includes a polymerization initiator, and more preferably includes a photopolymerization initiator.

As the polymerization initiator, a known polymerization initiator can be used.

In addition, the polymerization initiator is preferably a photopolymerization initiator capable of initiating a polymerization reaction by ultraviolet irradiation.

Examples of the photopolymerization initiator include a-carbonyl compounds (described in U.S. Pat. Nos. 2,367,661A and 2,367,670A), acyloin ether compounds (described in U.S. Pat. No. 2,448,828A), a-hydrocarbon-substituted aromatic acyloin compounds (described in U.S. Pat. No. 2,722,512A), polynuclear quinone compounds (described in U.S. Pat. Nos. 3,046,127A and 2,951,758A), combinations of triarylimidazole dimer and p-aminophenyl ketone (described in U.S. Pat. No. 3,549,367A), acridine compounds and phenazine compounds (described in JP1985-105667A (JP-S60-105667A) and U.S. Pat. No. 4,239,850A), and oxadiazole compounds (described in U.S. Pat. No. 4,212,970A).

In addition, as the photoradical polymerization initiator, a known photoradical polymerization initiator can be used.

Preferred examples of the photoradical polymerization initiator include α-hydroxyalkylphenone compounds, α-aminoalkylphenone compounds, acylphosphine oxide compounds, thioxanthone compounds, and oxime ester compounds.

Furthermore, as the photocationic polymerization initiator, a known photocationic polymerization initiator can be used.

Preferred examples of the photocationic polymerization initiator include iodonium salt compounds and sulfonium salt compounds.

The above-described liquid crystal layer may include one polymerization initiator alone, or may include two or more polymerization initiators.

The content of the polymerization initiator can be appropriately selected according to the desired pitch of the structure and helical structure of the cholesteric liquid crystal compound to be used. However, from the viewpoint of ease of adjusting the pitch of the helical structure, polymerization rate, and strength of the liquid crystal layer after curing, the content of the polymerization initiator is preferably 0.05% by mass to 10% by mass, more preferably 0.05% by mass to 5% by mass, still more preferably 0.1% by mass to 4% by mass, and particularly preferably 0.2% by mass to 3% by mass with respect to the total mass of the above-described liquid crystal layer.

—Crosslinking Agent—

The above-described liquid crystal layer may include a crosslinking agent in order to improve the strength and durability of the liquid crystal layer after curing. As the crosslinking agent, a crosslinking agent which cures the liquid crystal composition with ultraviolet rays, heat, humidity, and the like can be suitably used.

The crosslinking agent is not particularly limited and can be appropriately selected according to the purpose, and examples thereof include polyfunctional acrylate compounds such as trimethylolpropane tri(meth)acrylate and pentaerythritol tri(meth)acrylate; epoxy compounds such as glycidyl (meth)acrylate, ethylene glycol diglycidyl ether, and 3′,4′-epoxycyclohexylmethyl 3,4-epoxycyclohexanecarboxylate; oxetane compounds such as 2-ethylhexyloxetane and xylylenebisoxetane; aziridine compounds such as 2,2-bishydroxymethylbutanol-tris[3 -(1-aziridinyl)propionate] and 4,4-bis(ethyleneiminocarbonylamino); isocyanate compounds such as hexamethylene diisocyanate and biuret-type isocyanate; polyoxazoline compounds having an oxazoline group in the side chain; and alkoxysilane compounds such as vinyltrimethoxysilane and N-(2-aminoethyl) 3-aminopropyltrimethoxysilane. In addition, a known catalyst can be used depending on reactivity of the crosslinking agent, and in addition to improving the strength and durability of the liquid crystal layer, productivity can be improved.

The above-described liquid crystal layer may include one crosslinking agent alone, or may include two or more chiral agents.

From the viewpoint of the strength and durability of the liquid crystal layer, the content of the crosslinking agent is preferably 1% by mass to 20% by mass and more preferably 3% by mass to 15% by mass with respect to the total mass of the above-described liquid crystal layer.

—Polyfunctional Polymerizable Compound—

From the viewpoint of suppressing change in reflectance after molding, the above-described liquid crystal layer preferably includes a polyfunctional polymerizable compound.

Examples of the polyfunctional polymerizable compound include, in the above-described compounds, cholesteric liquid crystal compounds having two or more ethylenic unsaturated groups and no cyclic ether group; cholesteric liquid crystal compounds having two or more cyclic ether groups and no ethylenic unsaturated group; cholesteric liquid crystal compounds having two or more ethylenic unsaturated groups and two or more cyclic ether groups; chiral agents having two or more polymerizable groups; and the above-described crosslinking agent.

Preferred examples of the above-described ethylenic unsaturated group include a (meth)acrylic group, and more preferred examples thereof include a (meth)acryloxy group.

Preferred examples of the above-described cyclic ether group include an epoxy group and an oxetanyl group, and more preferred examples thereof include an oxetanyl group.

Among these, as the polyfunctional polymerizable compound, at least one compound selected from the group consisting of cholesteric liquid crystal compounds two or more ethylenic unsaturated groups and no cyclic ether group, cholesteric liquid crystal compounds having two cyclic ether groups and no ethylenic unsaturated group, and chiral agents having two or more polymerizable groups is preferable, and chiral agents having two or more polymerizable groups are more preferable.

From the viewpoint of suppressing change in reflectance after molding, the content of the polyfunctional polymerizable compound is preferably 0.5% by mass to 70% by mass, more preferably 1% by mass to 50% by mass, still more preferably 1.5% by mass to 20% by mass, and particularly preferably 2% by mass to 10% by mass with respect to the total mass of the above-described liquid crystal layer.

—Other Additives—

The above-described liquid crystal layer may include other additives other than those described above as necessary.

As other additives, a known additive can be used, and examples thereof include a surfactant, a polymerization inhibitor, an antioxidant, a horizontal alignment agent, an ultraviolet absorber, a light stabilizer, a colorant, and metal oxide particles.

In addition, the above-described liquid crystal layer may include a solvent. The solvent is not particularly limited and can be selected according to the purpose, but an organic solvent is preferably used.

The organic solvent is not particularly limited and can be selected according to the purpose, and examples thereof include ketones such as methyl ethyl ketone and methyl isobutyl ketone, alkyl halides, amides, sulfoxides, heterocyclic compounds, hydrocarbons, esters, ethers, and alcohols. The solvent may be used alone or in combination of two or more kinds thereof. Among these, in consideration of burden on the environment, ketones are particularly preferable. In addition, the above-described component may function as the solvent.

The content of the solvent in the above-described liquid crystal layer after curing is preferably 5% by mass or less, more preferably 3% by mass or less, still more preferably 2% by mass or less, and particularly preferably 1% by mass or less with respect to the total mass of the above-described liquid crystal layer.

˜Formation of Liquid Crystal Layer—

The formation of the above-described liquid crystal layer can be performed by a method of developing a liquid crystal composition including each of the above-described components in a solution state with the solvent or in a liquid state, such as a molten liquid by heating, according to an appropriate method such as a roll coating method, a gravure printing method, and a spin coating method. Furthermore, the formation of the above-described liquid crystal layer can be performed according to various methods such as a wire bar coating method, an extrusion coating method, a direct gravure coating method, a reverse gravure coating method, and a die-coating method. In addition, using an inkjet device, the above-described liquid crystal composition can be discharged from a nozzle to form a coating film.

In a case of using the above-described solvent, it is preferable that the liquid crystal layer is dried by a known method after applying the above-described liquid crystal composition. For example, the coating film may be dried by allowing to stand or by heating.

In addition, it is preferable that the cholesteric liquid crystal compound in the above-described liquid crystal layer are aligned in the above-described liquid crystal layer after application and drying of the above-described liquid crystal composition.

—Selective Reflectivity of Liquid Crystal Layer—

The above-described liquid crystal layer preferably has selective reflectivity in a specific wavelength range.

In the present specification, a selective reflection wavelength refers to an average value of two wavelengths indicating T½ (%): a half-value transmittance expressed by the following expression, in a case where the minimum value of the transmittance of a target object (a member) is defined as Tmin (%). Having selective reflectivity means having a specific wavelength range which satisfies the selective reflection wavelength.

Expression for calculating half-value transmittance: T½=100−(100−Tmin)/2

The selective reflection wavelength in the above-described liquid crystal layer is not particularly limited, and for example, can be set to any range of visible light (380 nm to 780 nm) and near-infrared light (more than 780 nm and 2,000 nm or less).

Among these, it is preferable that the above-described liquid crystal layer has selective reflectivity in at least a part of wavelength range of 380 nm to 1,200 nm.

˜Layer Configuration of Liquid Crystal Layer—

The above-described liquid crystal layer may be formed by only one layer, or may be formed by two or more layers.

In addition, each of the two or more liquid crystal layers may have the same composition or different compositions, and it is sufficient that at least one layer may be a layer including the cholesteric liquid crystal compound and the photoisomerization compound. In addition, the above-described liquid crystal layer may further have a layer including no photoisomerization compound.

˜Thickness of Liquid Crystal Layer—

From the viewpoint of suppressing change in reflectance after molding, the thickness of the above-described liquid crystal layer is preferably less than 10 μm, more preferably 5 μm or less, more preferably 0.05 μm to 5 μm, and particularly preferably 0.1 μm to 4 μm.

In a case of having two or more of the above-described liquid crystal layer, it is preferable that the liquid crystal layers each independently have a thickness within the above-described thickness range.

<<Alignment Layer>>

The decorative film for molding manufactured by the method for manufacturing a decorative film for molding according to the embodiment of the present disclosure may have an alignment layer in contact with the above-described liquid crystal layer. The alignment layer is used for aligning the molecules of the cholesteric liquid crystal compound in the liquid crystal layer in a case of forming the above-described liquid crystal layer.

The alignment layer is used in a case of forming a layer such as a liquid crystal layer. The decorative film may or may not include the alignment layer.

The alignment layer can be provided by a method of a rubbing treatment of an organic compound (preferably a polymer), an oblique vapor deposition of an inorganic compound such as SiO, a formation of a layer having a microgroove, and the like. Furthermore, an alignment layer in which an alignment function occurs by application of an electric field, application of a magnetic field, or light irradiation has also been known.

Depending on the material of an underlayer such as the base material and the liquid crystal layer, the alignment layer may be provided, or the underlayer may be subjected to a direct alignment treatment (for example, rubbing treatment) to function as an alignment layer. Polyethylene terephthalate (PET) can be mentioned as an example of such a support as the underlayer.

In addition, in a case where a layer is directly laminated on the liquid crystal layer, in some cases, the liquid crystal layer as the underlayer behaves as the alignment layer and the cholesteric liquid crystal compound for forming an upper layer can be aligned. In such a case, the cholesteric liquid crystal compound in the upper layer can be aligned without providing the alignment layer or performing a special alignment treatment (for example, rubbing treatment).

Hereinafter, as a preferred example, a rubbing-treated alignment layer which is used by subjecting a surface to a rubbing treatment, and a photo alignment layer will be described.

—Rubbing-Treated Alignment Layer—

Examples of a polymer which can be used in the rubbing-treated alignment layer include a methacrylate-based copolymer, a styrene-based copolymer, polyolefin, polyvinyl alcohol and modified polyvinyl alcohol, poly(N-methylol acrylamide), polyester, polyimide, a vinyl acetate copolymer, carboxymethyl cellulose, and polycarbonate, which are described in paragraph 0022 of JP1996-338913A (JP-H08-338913A). A silane coupling agent can be used as the polymer. As the polymer which can be used in the rubbing-treated alignment layer, a water-soluble polymer (for example, poly(N-methylol acrylamide), carboxymethyl cellulose, gelatin, polyvinyl alcohol, and modified polyvinyl alcohol) is preferable, gelatin, polyvinyl alcohol, or modified polyvinyl alcohol is more preferable, and polyvinyl alcohol or modified polyvinyl alcohol is particularly preferable.

The molecules of the liquid crystal compound are aligned by coating a rubbing-treated surface of the alignment layer with the above-described liquid crystal composition. Thereafter, as necessary, by reacting the alignment layer polymer with a polyfunctional monomer included in the above-described liquid crystal layer, or by crosslinking the alignment layer polymer using a crosslinking agent, the above-described liquid crystal layer can be formed.

The thickness of the alignment layer is preferably in a range of 0.01 μm to 10 μm.

—Rubbing Treatment—

The surface of the alignment layer, the base material, or other layers, to be coated with the above-described liquid crystal composition, may be subjected to a rubbing treatment as necessary. The rubbing treatment can be generally performed by rubbing a surface of a film containing a polymer as a main component with paper or cloth in a certain direction. The general method of the rubbing treatment is described in, for example, “Handbook of Liquid crystals” (published by Maruzen, Oct. 30, 2000).

As a method of changing a rubbing density, the method described in “Handbook of Liquid crystals” (published by Maruzen) can be used. The rubbing density (L) is quantified by Expression (A).

$$L = N I ( 1 + 2 π r n / 60 v ) \qquad Expression ( A )$$

In Expression (A), N is the number of times of rubbing, I is a contact length of a rubbing roller, r is a radius of the roller, n is a rotation speed (rpm) of the roller, and v is a stage moving speed (speed per second).

In order to increase the rubbing density, it is sufficient that the number of times of rubbing is increased, the contact length of the rubbing roller is increased, the radius of the roller is increased, the rotation speed of the roller is increased, or the stage moving speed is decreased. On the other hand, in order to decrease the rubbing density, it is sufficient that the reverse is carried out. In addition, with regard to conditions of the rubbing treatment, the description in JP4052558B can be referred to.

—Photo Alignment Layer—

A photo alignment material used for the photo alignment layer formed by light irradiation is described in many references. Preferred examples thereof include azo compounds described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B; aromatic ester compounds described in JP2002-229039A; maleimide and/or alkenyl-substituted nadiimide compounds having a photo alignment unit, described in JP2002-265541A and JP2002-317013A; photo-crosslinkable silane derivatives described in JP4205195B and JP4205198B; and photo-crosslinkable polyimides, polyamides, or esters described in JP2003-520878A, JP2004-529220A, and JP4162850B. Azo compounds or photo-crosslinkable polyimides, polyamides, or esters are particularly preferable.

The photo alignment layer is produced by subjecting the photo alignment layer formed of the above-described material to an irradiation of linearly polarized light or non-polarized light.

In the present specification, the “irradiation of linearly polarized light” is an operation for causing a photo-reaction of the photo alignment material. The wavelength of the light used depends on the photo alignment material used, and is not particularly limited as long as a wavelength necessary for the photo-reaction. The light used for light irradiation is preferably light having a peak wavelength of 200 nm to 700 nm and the light is more preferably UV light having a peak wavelength of 400 nm or less.

Examples of a light source used for light irradiation include known light sources, for example, lamps such as a tungsten lamp, a halogen lamp, a xenon lamp, a xenon flash lamp, a mercury lamp, a mercury-xenon lamp, and a carbon arc lamp, various lasers (such as semiconductor laser, helium neon laser, argon ion laser, helium cadmium laser, and YAG laser), light emitting diodes, cathode ray tube, and the like.

As a method for obtaining the linearly polarized light, a method of using a polarizing plate (for example, iodine polarizing plate, dichroic coloring agent polarizing plate, and wire grid polarizing plate), a method of using a prismatic element (for example, Glan-Thomson prism) or a reflective type polarizer using Brewster's angle, or a method of using light emitted from a polarized laser light source can be adopted. In addition, by using a filter, a wavelength conversion element, or the like, only light having a required wavelength may be irradiated selectively.

In a case where the irradiated light is the linearly polarized light, a method of irradiating, from the upper surface or the back surface, the alignment layer with the light perpendicularly or obliquely to the surface of the alignment layer is exemplified. The incidence angle of the light varies depending on the photo alignment material, but is preferably 0° to 90° (perpendicular) and more preferably 40° to 90° with respect to the alignment layer.

In a case of using the non-polarized light, the non-polarized light is irradiated obliquely. The incidence angle of the light is preferably 10° to 80°, more preferably 20° to 60°, and particularly preferably 30° to 50°.

The irradiation time is preferably 1 minute to 60 minutes and more preferably 1 minute to 10 minutes.

<<Colored Layer>>

From the viewpoint of designability, the decorative film for molding manufactured by the method for manufacturing a decorative film for molding according to the embodiment of the present disclosure preferably further has a colored layer. The above-described colored layer is a layer including a colorant.

The position of the colored layer is not particularly limited. The colored layer can be provided at a desired position, and preferred examples thereof include the following two aspects.

In one aspect, from the viewpoint of designability, the decorative film for molding according to the embodiment of the present disclosure further has a colored layer between the above-descried base material and the above-described liquid crystal layer.

In another aspect, from the viewpoint of designability, moldability, and durability, the decorative film for molding according to the embodiment of the present disclosure further has a colored layer on the above-described liquid crystal layer on a side opposite to a side provided with the above-described base material.

In addition, the colored layer may have only one layer, or may have two or more layers.

In the above-described decorative film for molding, it is preferable that at least one of the colored layers is a layer for viewing through the above-described liquid crystal layer.

By viewing at least one of the colored layers through the above-described liquid crystal layer, it is presumed that, based on the anisotropy depending on an angle of incidence ray in the above-described liquid crystal layer, the change in color occurs depending on the angle at which the colored layer is viewed, and special designability is exhibited.

In addition, in a case where the decorative film for molding according to the embodiment of the present disclosure has two or more colored layers, preferred examples of an aspect of the two or more colored layers include an aspect in which at least one of the colored layers is a layer for viewing through the above-described liquid crystal layer, and at least one other layer of the colored layers is a layer (also referred to as a “color filter layer”) closer to a viewing direction than the above-described liquid crystal layer. The “closer to a viewing direction” means that it is close to the viewer in a case of being viewed.

The colored layer (color filter layer) closer to a viewing direction than the above-described liquid crystal layer is a layer having high transparency to light having at least a specific wavelength. The layer configuration thereof is not particularly limited, and may be a single color filter layer or may be a color filter layer having a color filter structure of two or more colors and having a black matrix or the like as necessary.

By having the above-described color filter layer, it is possible to obtain a decorative film for molding, which has further designability and can view only a specific wavelength range.

In addition, the total light transmittance of the colored layer for viewing through at least one layer of the colored layer, preferably the above-described liquid crystal layer, is preferably 10% or less from the viewpoint of visibility.

The color of the colored layer is not limited, and can be appropriately selected depending on the application of the decorative film for molding, and the like. Examples of the color of the colored layer include black, gray, white, red, orange, yellow, green, blue, and violet. In addition, the color of the colored layer may be a metallic color.

From the viewpoint of strength and scratch resistance, the colored layer preferably includes a resin. Examples of the resin include a binder resin described later. In addition, the colored layer may be a layer formed by curing a polymerizable compound, or may be a layer including a polymerizable compound and a polymerization initiator.

The polymerizable compound and polymerization initiator are not particularly limited, and a known polymerizable compound and polymerization initiator can be used.

—Colorant—

Examples of the colorant include a pigment and a dye, and from the viewpoint of durability, a pigment is preferable. In order to make the colored layer metallic, metal particles, pearl pigments, and the like can be applied, and methods such as vapor deposition and plating can also be adopted.

The pigment is not limited, and a known inorganic pigment, organic pigment, and the like can be applied.

Examples of the inorganic pigment include white pigments such as titanium dioxide, zinc oxide, lithopone, light calcium carbonate, white carbon, aluminum oxide, aluminum hydroxide, and barium sulfate; black pigments such as carbon black, titanium black, titanium carbon, iron oxide, and graphite; barium yellow; cadmium red; and chrome yellow.

As the inorganic pigment, inorganic pigments described in paragraph 0015 and paragraph 0114 of JP2005-007765A can also be applied.

Examples of the organic pigment include phthalocyanine-based pigments such as phthalocyanine blue and phthalocyanine green; azo-based pigments such as azo red, azo yellow, and azo orange; quinacridone-based pigments such as quinacridone red, cinquasia red, and cinquasia magenta; perylene pigments such as perylene red and perylene maroon; anthrapyridine; flavanthrone yellow; isoindoline yellow; indanthrone blue; dibromanzathrone red; anthraquinone red; and diketopyrrolopyrrole.

Specific examples of the organic pigment include red pigments such as C. I. Pigment Red 177, 179, 224, 242, 254, 255, and 264; yellow pigments such as C. I. Pigment Yellow 138, 139, 150, 180, and 185; orange pigments such as C. I. Pigment Orange 36, 38, and 71; green pigments such as C. I. Pigment Green 7, 36, and 58; blue pigments such as C. I. Pigment Blue 15:6; and violet pigments such as C. I. Pigment Violet 23.

As the organic pigment, organic pigments described in paragraph 0093 of JP2009-256572A can also be applied.

As the pigment, a pigment (so-called bright pigment) having a light-transmitting property and light-reflecting property may be included. Examples of the bright pigment include metallic bright pigments such as aluminum, copper, zinc, iron, nickel, tin, aluminum oxide, and alloys thereof, interference mica pigments, white mica pigments, graphite pigments, and glass flake pigments. The bright pigment may be uncolored or colored.

In a case where exposure is performed in the molding of the decorative film for molding, the bright pigment is preferably used in a range which does not hinder the curing by exposure.

The colorant may be used alone or in combination of two or more kinds thereof In addition, in a case where two or more kinds of colorants are used, the inorganic pigment and the organic pigment may be used in combination.

From the viewpoint of a target color development and molding process suitability, the content of the colorant in the colored layer is preferably 1% by mass to 50% by mass, more preferably 5% by mass to 50% by mass, and particularly preferably 10% by mass to 40% by mass with respect to the total mass of the colored layer.

—Dispersant—

From the viewpoint of improving dispersibility of the colorant included in the colored layer, particularly the pigment, the colored layer may contain a dispersant. By containing the dispersant, dispersibility of the colorant in the formed colored layer is improved, and the color of the decorative film to be obtained can be uniformized.

The dispersant can be appropriately selected and used according to the type, shape, and the like of the colorant, but is preferably a polymer dispersant.

Examples of the polymer dispersant include silicone polymers, acrylic polymers, and polyester polymers. In a case where it is desired to impart heat resistance to the decorative film, silicone polymers such as a graft type silicone polymer are preferably used as the dispersant.

The weight-average molecular weight of the dispersant is preferably 1,000 to 5,000,000, more preferably 2,000 to 3,000,000, and particularly preferably 2,500 to 3,000,000. In a case where the weight-average molecular weight is 1,000 or more, dispersibility of the colorant is further improved.

As the dispersant, a commercially available product may be used. Examples of the commercially available product include EFKA 4300 (acrylic polymer dispersant) manufactured by BASF Japan; HOMOGENOL L-18, HOMOGENOL L-95, and HOMOGENOL L-100 manufactured by Kao Corporation; Solsperse 20000 and Solsperse 24000 manufactured by Lubrizol Corporation; and DISPERBYK-110, DISPERBYK-164, DISPERBYK-180, and DISPERBYK-182 manufactured by BYK Chemie Japan. Note that, “HOMOGENOL”, “Solsperse”, and “DISPERBYK” are all registered trademarks.

The dispersant may be used alone or in combination of two or more kinds thereof.

The content of the dispersant in the colored layer is preferably 1 part by mass to 30 parts by mass with respect to 100 parts by mass of the colorant.

—Binder Resin—

From the viewpoint of proper molding process, the colored layer preferably contains a binder resin.

The binder resin is not limited, and a known resin can be applied. From the viewpoint of obtaining a desired color, as the binder resin, a transparent resin is preferable, and specifically, a resin having a total light transmittance of 80% or more is preferable. The total light transmittance can be measured by a spectrophotometer (for example, spectrophotometer UV-2100 manufactured by Shimadzu Corporation).

Examples of the binder resin include acrylic resins, silicone resins, polyesters, polyurethanes, and polyolefins. The binder resin may be a homopolymer of a specific monomer or a copolymer of the specific monomer and another monomer.

The binder resin may be used alone or in combination of two or more kinds thereof.

From the viewpoint of moldability, the content of the binder resin in the colored layer is preferably 5% by mass to 70% by mass, more preferably 10% by mass to 60% by mass, and particularly preferably 20% by mass to 60% by mass with respect to the total mass of the colored layer.

—Additive—

The colored layer may contain an additive as necessary, in addition to the above-described components. The additive is not limited, and a known additive can be applied. Examples of the additive include surfactants described in paragraph 0017 of JP4502784B and paragraphs 0060 to 0071 of JP2009-237362A, thermal polymerization inhibitor described in paragraph 0018 of JP4502784B (also referred to as a polymerization inhibitor; preferred examples thereof include phenothiazine), and other additives described in paragraphs 0058 to 0071 of JP2000-310706.

—Method for Forming Colored Layer—

Examples of a method for forming the colored layer include a method of using a composition for forming the colored layer, and a method of attaching colored films to each other. Among the above, as a method for forming the colored layer, a method of using a composition for forming the colored layer is preferable. In addition, the colored layer may be formed by using a commercially available paint such as Nax REAL series, Nax Admila series, and Nax Multi series (manufactured by NIPPONPAINT Co., Ltd.) and RETAN PG series (manufactured by Kansai Paint Co., Ltd.).

Examples of the method of using the composition for forming the colored layer include a method of applying the composition for forming the colored layer to form a colored layer, and a method of printing the composition for forming the colored layer to form a colored layer. Examples of the printing method include screen printing, inkjet printing, flexographic printing, gravure printing, and offset printing.

The composition for forming the colored layer includes a colorant. In addition, the composition for forming the colored layer preferably includes an organic solvent, and may include each of the above-described components which can be contained in the colored layer.

The content of each of the above-described components which can be contained in the composition for forming the colored layer is preferably adjusted within a range of the amount in which, in the descriptions regarding the content of each of the above-described components in the colored layer, the “colored layer” is read as the “composition for forming the colored layer”.

The organic solvent is not limited, and a known organic solvent can be applied. Examples of the organic solvent include alcohol compounds, ester compounds, ether compounds, ketone compounds, and aromatic hydrocarbon compounds.

The organic solvent may be used alone or in combination of two or more kinds thereof.

The content of the organic solvent in the composition for forming the colored layer is preferably 5% by mass to 90% by mass and more preferably 30% by mass to 70% by mass with respect to the total mass of the composition for forming the colored layer.

Examples of a method of preparing the composition for forming the colored layer include a method of mixing, for example, the organic solvent and components contained in the colored layer, such as the colorant. In addition, in a case where the composition for forming the colored layer includes a pigment as the colorant, from the viewpoint of improving uniform dispersibility and dispersion stability of the pigment, it is preferable to prepare the composition for forming the colored layer by using a pigment dispersion liquid including a pigment and a dispersant.

—Thickness of Colored Layer—

The thickness of the colored layer is not particularly limited, but from the viewpoint of visibility and three-dimensional moldability, is preferably 0.5 μm or more, more preferably 3 μm or more, still more preferably 3 μm to 50 and particularly preferably 3 μm to 20 μm.

In a case of having two or more colored layers, it is preferable that the colored layers each independently have a thickness within the above-described thickness range.

<<Protective Layer>>

The decorative film for molding manufactured by the method for manufacturing a decorative film for molding according to the embodiment of the present disclosure preferably has a protective layer.

The protective layer may be a layer having sufficient strength to protect the above-described liquid crystal layer and the like, and having excellent weather fastness to ultraviolet light (UV light), moist heat, and the like. In addition, from the viewpoint of visibility and black tightness (suppression of reflected glare by reflected light from the outside, for example, suppression of reflected glare of fluorescent lamp), the protective layer may be a protective layer having antireflection function.

From the viewpoint of strength and weather fastness, the protective layer preferably includes a resin, more preferably includes at least one resin selected from the group consisting of a siloxane resin, a fluororesin, an acrylic resin, a melamine resin, a polyolefin resin, a polyester resin, a polycarbonate resin, and a urethane resin, and still more preferably includes at least one resin selected from the group consisting of a siloxane resin having voids, a fluororesin, an acrylic resin, and a urethane resin.

In addition, in a case of forming a protective layer having voids, in a case where the protective layer includes a siloxane resin or a fluororesin, the refractive index of the protective layer can be set to 1.5 or less, preferably 1.4 or less, and a protective layer also having excellent antireflection function is easily obtained. In addition, by including the low refractive index particles, the same antireflection effect is obtained even in a case where the refractive index of the protective layer is lowered to 1.5 or less.

The fluororesin is not particularly limited, but examples thereof include resins described in paragraphs 0076 to 0106 of JP2009-217258A and paragraphs 0083 to 0127 of JP2007-229999A.

Examples of the fluororesin include a fluorinated alkyl resin in which a hydrogen atom in olefin is replaced by a fluorine atom, and include polytetrafluoroethylene, polychlorotrifluoroethylene, polyvinylidene fluoride, polyvinyl fluoride, perfluoroalkoxy alkane, a copolymer such as perfluoroethylene propene, ethylene tetrafluoroethylene, and a water-dispersed fluororesin dispersion copolymerized with an emulsifier and a component which enhances affinity with water. Specific examples of such a fluororesin include LUMIFLON and Obbligato manufactured by AGC Inc., ZEFFLE and NEOFLON manufactured by DAIKIN INDUSTRIES, LTD., Teflon (registered trademark) manufactured by Dupont, and KYNAR manufactured by ARKEMA.

In addition, for example, a compound having at least one group of polymerizable functional groups and crosslinking functional groups, and containing a fluorine atom may be used, and examples thereof include radically polymerizable monomers such as perfluoroalkyl (meth)acrylate, a vinyl fluoride monomer, and a vinylidene fluoride monomer, and cationically polymerizable monomers such as perfluorooxetane. Specific examples of such a fluorine compound include LINC3A manufactured by KYOEISHA CHEMICAL CO., LTD, OPTOOL manufactured by DAIKIN INDUSTRIES, LTD., OP STAR manufactured by Arakawa Chemical Industries, Ltd., and tetrafluorooxetane manufactured by DAIKIN INDUSTRIES, LTD.

The low refractive index particles, preferably particles having a refractive index of 1.45 or less, are not particularly limited, and examples thereof include particles described in paragraphs 0075 to 0103 of JP2009-217258A.

Examples of the low refractive index particles include hollow particles using inorganic oxide particles such as silica or resin particles such as acrylic resin particles, porous particles having a porous structure on the particle surface, and fluoride particles with low refractive index of the material itself.

Specific examples of such hollow particles include THRULYA manufactured by JGC C&C, SiliNax manufactured by Nittetsu Mining Co., Ltd., TECHPOLYMER MBX, SBX, NH manufactured by Sekisui Kasei Co., Ltd., and multi-hollow particles, specific examples of the porous particles include Lightstar manufactured by Nissan Chemical Corporation, and specific examples of the fluoride particles include magnesium fluoride nanoparticles manufactured by RMML Co., Ltd. In addition, core-shell particles may be used to form closed voids in a matrix configured of the above-described resin.

As a method for forming a protective layer by applying a composition containing hollow particles, for example, a method described in paragraphs 0028 and 0029 of JP2009-103808A, a method described in paragraphs 0030 and 0031 of JP2008-262187A, or a method described in paragraph 0018 of JP2017-500384A can be applied.

—Siloxane Compound—

The coating solution for forming the protective layer preferably contains a siloxane compound. A suitable siloxane resin can be obtained by hydrolyzing and condensing the siloxane compound.

In particular, as the siloxane compound, at least one compound (hereinafter, also referred to as a specific siloxane compound) selected from the group consisting of a siloxane compound represented by Formula 1 and a hydrolyzed condensate of the siloxane compound represented Formula 1 is preferable.

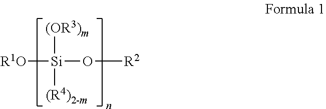

In Formula 1, R¹, R², and R³ each independently represent an alkyl group or alkenyl group having 1 to 6 carbon atoms; in a case of a plurality of R⁴'s, the plurality of R⁴'s each independently represent an alkyl group, a vinyl group, or an alkyl group having a group selected from the group consisting of a vinyl group, an epoxy group, a vinylphenyl group, a (meth)acryloxy group, a (meth)acrylamide group, an amino group, an isocyanurate group, a ureido group, a mercapto group, a sulfide group, a polyoxyalkyl group, a carboxy group, and a quaternary ammonium group; m represents an integer of 0 to 2; and n represents an integer of 1 to 20.

The hydrolyzed condensate of the siloxane compound represented Formula 1 refers to a compound obtained by condensing the siloxane compound represented Formula 1, and a compound in which at least one part of substituents on the silicon atom in the siloxane compound represented by Formula 1 is hydrolyzed to form a silanol group.

The alkyl group or alkenyl group having 1 to 6 carbon atoms in R¹, R², and R³ of Formula 1 may be linear, may have a branch, or may have a ring structure. From the viewpoint of strength, light-transmitting property, and haze of the protective layer, the alkyl group or alkenyl group having 1 to 6 carbon atoms is preferably an alkyl group.

Examples of the alkyl group having 1 to 6 carbon atoms include a methyl group, an ethyl group, a propyl group, an isopropyl group, an n-butyl group, a tert-butyl group, an n-pentyl group, an n-hexyl group, and a cyclohexyl group, and a methyl group or an ethyl group is preferable and a methyl group is more preferable.

From the viewpoint of strength, light-transmitting property, and haze of the protective layer, in a case of a plurality of R⁴'s, the plurality of R⁴'s in Formula 1 are each independently preferably an alkyl group and more preferably an alkyl group having 1 to 8 carbon atoms.

In addition, R⁴ in Formula 1 preferably has 1 to 40 carbon atoms, more preferably has 1 to 20 carbon atoms, and particularly preferably 1 to 8 carbon atoms.

From the viewpoint of strength, light-transmitting property, and haze of the protective layer, m in Formula 1 is preferably 1 or 2 and more preferably 2.

From the viewpoint of strength, light-transmitting property, and haze of the protective layer, n in Formula 1 is preferably an integer of 2 to 20.

Examples of the specific siloxane compound include KBE-04, KBE-13, KBE-22, KBE-1003, KBM-303, KBE-403, KBM-1403, KBE-503, KBM-5103, KBE-903, KBE-9103P, KBE-585, KBE-803, KBE-846, KR-500, KR-515, KR-516, KR-517, KR-518, X-12-1135, X-12-1126, and X-12-1131 manufactured by Shin-Etsu Chemical Co., Ltd.; Dynasylan 4150 manufactured by Evonik Japan; MKC Silicate MS51, MS56, MS57, and MS56S manufactured by Mitsubishi Chemical Corporation.; and Ethyl Silicate 28, N-Propyl Silicate, N-Butyl Silicate, and SS-101 manufactured by Colcoat Co., Ltd.

In addition, the coating solution for forming the protective layer may contain a condensation catalyst which promotes condensation of the siloxane compound.

In a case where the coating solution for forming the protective layer contains the condensation catalyst, a protective layer having durability can be formed.

The condensation catalyst is not particularly limited, and a known condensation catalyst can be used.

—Urethane Resin—

The urethane resin which can be suitably used in the present disclosure can be obtained by a reaction of a diisocyanate compound with a polyol, a polymerization reaction of a urethane acrylate compound, or the like.

Examples of the polyol used for synthesizing the polyurethane resin include polyester polyol, polyether polyol, polycarbonate polyol, and polyacrylic polyol. Among these, polyester polyol or polyacrylic polyol is preferable from the viewpoint of impact resistance.

The polyester polyol can be obtained by a known method using an esterification reaction of a polybasic acid and a polyhydric alcohol.

A polycarboxylic acid is used as the polybasic acid component of the polyester polyol, but as necessary, a monobasic fatty acid or the like may be used together. Examples of the polycarboxylic acid include phthalic acid, isophthalic acid, terephthalic acid, tetrahydrophthalic acid, tetrahydroisophthalic acid, hexahydrophthalic acid, hexahydroterephthalic acid, trimellitic acid, pyromellitic acid, other such aromatic polycarboxylic acids, adipic acid, sebacic acid, succinic acid, azelaic acid, fumaric acid, maleic acid, itaconic acid, other such aliphatic polycarboxylic acids, and anhydrides of these acids. These polybasic acids may be used alone or in combination of two or more kinds thereof.

Examples of the polyhydric alcohol of the polyester polyol and examples of the polyhydric alcohol used in the synthesis of the polyurethane resin include glycols and tri or higher-hydric polyhydric alcohols. Examples of the glycol include ethylene glycol, propylene glycol, diethylene glycol, triethylene glycol, tetraethylene glycol, dipropylene glycol, polyethylene glycol, polypropylene glycol, neopentyl glycol, hexylene glycol, 1,3-butanediol, 1,4-butanediol, 1,5-pentanediol, 1,6-hexanediol, 2-butyl -2-ethyl-1,3 -propanediol, methylpropanediol, cyclohexanedimethanol, and 3,3-diethyl-1,5-pentanediol. Examples of the tri or higher-hydric polyhydric alcohol include glycerol, trimethylolethane, trimethylolpropane, pentaerythritol, and dipentaerythritol. These polyhydric alcohols may be used alone or in combination of two or more kinds thereof.

Examples of dimethylol alkanoate include dimethylol propionate, dimethylol butane, dimethylol pentanate, dimethylol heptanate, dimethylol octanate, and dimethylol nonanoate. These dimethylol alkanoates may be used alone or in combination of two or more kinds thereof

As the polyacrylic polyol, various known polyacrylic polyols having a hydroxy group capable of reacting with an isocyanate group can be used. Examples thereof include polyacrylic polyols in which at least one or more of (meth)acrylic acid, various (meth)acrylic acids with an added hydroxy group, (meth)acrylic acid alkyl esters, (meth)acrylic amides and derivatives thereof, carboxylate esters of vinyl alcohol, unsaturated carboxylic acids, or hydrocarbons having a chain-like unsaturated alkyl moiety is a monomer.

Examples of polyisocyanate compounds include aromatic diisocyanates such as 4,4′-diphenylmethane diisocyanate, 2,4- or 2,6-tolylene diisocyanate, 1,5-naphthalene diisocyanate, p- or m-phenylene diisocyanate, xylylene diisocyanate, and m-tetramethylxylylene diisocyanate; alicyclic diisocyanates such as isophorone diisocyanate, 4,4′-dicyclohexylmethane diisocyanate, 1,4-cyclohexylene diisocyanate, and hydrogenated tolylene diisocyanate; and aliphatic diisocyanates such as hexamethylene diisocyanate. Among these, the alicyclic diisocyanate is preferable in terms of resistance to fading and the like. These diisocyanate compounds may be used alone or in combination of two or more kinds thereof

The urethane (meth)acrylate will be described. Examples of a method for producing the above-described urethane (meth)acrylate include a method in which a compound having a hydroxy group and a (meth)acryloyl group and a polyisocyanate compound are subjected to a urethanization reaction.

Examples of the above-described compound having a hydroxy group and a (meth)acryloyl group include monofunctional (meth)acrylates having a hydroxy group, such as 2-hydroxyethyl (meth)acrylate, 3-hydroxypropyl (meth)acrylate, 4-hydroxy-n-butyl (meth)acrylate, 2-hydroxypropyl (meth) acrylate, 2-hydroxy-n-butyl (meth)acrylate, 3-hydroxy-n-butyl (meth)acrylate, 1,4-cyclohexanedimethanol mono(meth)acrylate, N-(2-hydroxyethyl) (meth)acrylamide, glycerin mono(meth)acrylate, polyethylene glycol mono(meth)acrylate, polypropylene glycol mono(meth)acrylate, 2-hydroxy-3-phenoxypropyl (meth)acrylate, 2-(meth)acryloyloxyethyl-2-hydroxyethylphthalate, and lactone-modified (meth)acrylate having a hydroxy group at the end; and polyfunctional (meth)acrylates having a hydroxy group, such as trimethylolpropane di(meth)acrylate, ethylene oxide (EO)-modified diacrylate of isocyanurate, pentaerythritol tri(meth)acrylate, and dipentaerythritol penta(meth)acrylate. Among these, since scratch resistance of the protective layer is improved, pentaerythritol triacrylate or dipentaerythritol pentaacrylate is preferable. These compounds having a hydroxy group and a (meth)acryloyl group may be used alone or in combination of two or more kinds thereof.

Examples of the above-described polyisocyanate compound include aromatic diisocyanate compounds such as tolylene diisocyanate, diphenylmethane diisocyanate, m-xylylene diisocyanate, and m-phenylenebis(dimethylmethylene) diisocyanate; and aliphatic or alicyclic diisocyanate compounds such as hexamethylene diisocyanate, lysine diisocyanate, 1,3-bis(isocyanatomethyl) cyclohexane, 2-methyl-1,3-dii socyanato cyclohexane, 2-methyl-1,5-diisocyanato cyclohexane, 4,4′-dicyclohexylmethane diisocyanate, and isophorone diisocyanate.

The above-described urethane (meth)acrylate can be cured by irradiating with active light rays. The active light ray refers to ionizing radiation such as ultraviolet rays, electron beams, α rays, β rays, and γ rays. In a case where the protective layer is cured by, after molding, irradiating with ultraviolet rays as the active light ray, it is preferable to add a photopolymerization initiator to the protective layer to improve curability. In addition, as necessary, a photosensitizer can be added thereto to improve the curability.

—Surfactant—

The coating solution for forming the protective layer preferably contains a surfactant.

Examples of the surfactant include a nonionic surfactant, an anionic surfactant and a cationic surfactant which are an ionic surfactant, and an amphoteric surfactant, and any of these can be suitably used in the present disclosure.

—Other Components—

In addition to the above-described components, the coating solution for forming the protective layer can contain other components depending on the purpose.

As the other components, a known additive can be used, and examples thereof include an antistatic agent and a preservative.

Antistatic Agent

The coating solution for forming the protective layer may contain an antistatic agent.

The antistatic agent is used for the purpose of, by imparting antistatic property to the protective layer, suppressing adhesion of contaminants.

The antistatic agent for imparting antistatic property is not particularly limited.

As the antistatic agent used in the present disclosure, at least one selected from the group consisting of metal oxide particles, metal nanoparticles, conductive polymers, and ionic liquids can be preferably used. The antistatic agent may be used in combination of two or more kinds thereof.

The metal oxide particles need to be added in a relatively large amount in order to provide antistatic property, and since the metal oxide particles are inorganic particles, antifouling property of the protective layer can be further enhanced by containing the metal oxide particles.

The metal oxide particles are not particularly limited, and examples thereof include tin oxide particles, antimony-doped tin oxide particles, tin-doped indium oxide particles, zinc oxide particles, and silica particles.

Since the metal oxide particles have a large refractive index and, in a case where the particle diameter is large, it is concerned that light-transmitting property may be reduced due to scattering of transmitted light, the average primary particle diameter of the metal oxide particles is preferably 100 nm or less, more preferably 50 nm or less, and particularly preferably 30 nm or less. In addition, the lower limit value of the average primary particle diameter of the metal oxide particles is preferably 2 nm or more.

In addition, the shape of the particles is not particularly limited, and may be spherical, plate-shaped, or needle-shaped.

The average primary particle diameter of the metal oxide particles can be determined from a photograph obtained by observing dispersed particles using a transmission electron microscope. A prof ected area of the particles is obtained from an image of the photograph, and an equivalent circle diameter is obtained therefrom and defined as the average particle diameter (average primary particle diameter). As the average primary particle diameter in the present specification, a value calculated by measuring the projected area of 300 or more particles and calculating the equivalent circle diameter is used.

In a case where the shape of the metal oxide particles is not spherical, the average primary particle diameter may be determined using other methods, for example, dynamic light scattering method.

The coating solution for forming the protective layer may contain only one or two or more kinds of antistatic agents. In a case of containing two or more kinds of metal oxide particles, two or more kinds of metal oxide particles having different average primary particle diameters, shapes, and materials may be contained.

In the coating solution for forming the protective layer, the content of the antistatic agent is preferably 40% by mass or less, more preferably 30% by mass or less, and particularly preferably 20% by mass or less with respect to the total solid content of the coating solution for forming the protective layer.

By setting the content of the antistatic agent within the above-described range, the antistatic property can be effectively imparted to the protective layer without lowering film forming property of the coating solution for forming the protective layer.

In addition, in a case of using metal oxide particles as the antistatic agent, the content of the metal oxide particles is preferably 30% by mass or less, more preferably 20% by mass or less, and particularly preferably 10% by mass or less with respect to the total mass of the coating solution for forming the protective layer.

By setting the content of the metal oxide particles within the above-described range, dispersibility of the metal oxide particles in the coating solution for forming the protective layer is good, the occurrence of aggregation is suppressed, and the necessary antistatic property can be imparted to the protective layer.

A method used to form the protective layer is not particularly limited, and the protective layer can be formed by a method of forming the protective layer by applying a coating solution for forming the protective layer onto an underlayer of the protective layer and drying the coating solution, or by forming a pre-filmed protective layer by laminating or adhering with a pressure sensitive adhesive.

—Preparation of Coating Solution for Forming Protective Layer—

The method for preparing the coating solution for forming the protective layer is not particularly limited, and examples thereof include a method for manufacturing a coating solution for forming the protective layer by mixing an organic solvent, a surfactant, and water, dispersing the organic solvent in the water, adding the specific siloxane compound thereto, and partially hydrolyzing and condensing the mixture to form a shell layer on a surface of the organic solvent and to produce core-shell particles, and a method for manufacturing a coating solution for forming the protective layer by mixing an organic solvent, a surfactant, the above-described resin, and a monomer.

—Formation of Protective Layer—

The above-described coating solution for forming the protective layer is applied onto a layer corresponding to an underlayer of the protective layer to be formed and dried to form the protective layer.

The method of coating the underlayer with the coating solution for forming the protective layer is not particularly limited, and for example, any known coating method such as spray coating, brush coating, roller coating, bar coating, and dip coating can be applied.

In addition, before coating the underlayer with the coating solution for forming the protective layer, the underlayer to be coated with the coating solution for forming the protective layer may be subjected to a surface treatment such as a corona discharge treatment, a glow treatment, an atmospheric plasma treatment, a flame treatment, and an ultraviolet irradiation treatment.

The coating solution for forming the protective layer may be dried at room temperature (25° C.), or may be heated. From the viewpoint that the organic solvent contained in the coating solution for forming the protective layer is sufficiently volatilized, from the viewpoint that preferred light-transmitting property and suppression of coloration of the protective layer are obtained, and from the viewpoint of, in a case where a resin base material is used as the base material, heating at a temperature below the decomposition temperature of the resin base material, the coating solution for forming the protective layer is preferably dried by heating at 40° C. to 200° C. In addition, from the viewpoint of suppressing thermal deformation of the resin base material, the coating solution for forming the protective layer is more preferably dried by heating at 40° C. to 120° C.

In addition, the heating time in a case of heating is not particularly limited, but is preferably 1 minute to 30 minutes.

From the viewpoint of visibility and antireflection property, the refractive index of the protective layer in the present disclosure is preferably 1.05 to 1.6, more preferably 1.2 to 1.5, and still more preferably 1.2 to 1.4.

In the present disclosure, the refractive index is a refractive index for light having a wavelength of 550 nm at 25° C.

In addition, in order to make contamination such as wax and gasoline inconspicuous in a case of being used for exteriors of automobiles and the like, it is preferable to set the refractive index of the protective layer in a range close to those refractive indexes, that is, in a range of 1.4 to 1.5. In a case where the refractive index of the protective layer is within the range, stains such as wax and gasoline are less noticeable.

In addition, in the present disclosure, the thickness and refractive index of each layer are obtained by measuring, for a single film of a layer to be measured, which is formed on alkali-free glass OA-10G, a transmission spectrum using a spectrophotometer, and performing a fitting analysis using the transmittance obtained in the above measurement and a transmittance calculated by an optical interferometry. In addition, the refractive index can also be measured using a Kalnew precision refractometer (KPR-3000, manufactured by Shimadzu Corporation).

—Thickness of Protective Layer—

The thickness of the protective layer is not particularly limited, but from the viewpoint of scratch resistance and three-dimensional moldability, is preferably 2μm or more, more preferably 4 μm or more, still more preferably 4 μm to 50 μm, and particularly preferably 4 μm to 20 μm.

<<Resin Layer>>

In order to secure leveling of the above-described liquid crystal layer, the decorative film for molding manufactured by the method for manufacturing a decorative film for molding according to the embodiment of the present disclosure may further has a resin layer between the above-described liquid crystal layer and the above-described colored layer.

The resin layer is preferably a layer containing a resin of a type different from that of the protective layer.

From the viewpoint of visibility, the resin layer is preferably a transparent resin layer, and more preferably a layer formed of a transparent film.

The transparent film is not particularly limited as long as a transparent film having a required strength and scratch resistance.

In the present disclosure, the “transparent” in the transparent film means that the total light transmittance of the transparent film is 85% or more. The total light transmittance of the transparent film can be measured by the same method as the total light transmittance of the binder resin described above.

The transparent film is preferably a film formed of a transparent resin, and specific examples thereof include a resin film including a resin such as a polyethylene terephthalate (PET) resin, a polyethylene naphthalate (PEN) resin, an acrylic resin, a polycarbonate (PC) resin, triacetyl cellulose (TAC), and cycloolefin polymer (COP).

In particular, from the viewpoint of shape-following property to the mold, a resin film, including an acrylic resin, a polycarbonate resin, or a polyethylene terephthalate resin in an amount of 60% by mass or more (more preferably 80% by mass or more and still more preferably 100% by mass) with respect to total resin components included in the transparent film, is preferable. In particular, a resin film, including an acrylic resin in an amount of 60% by mass or more (more preferably 80% by mass or more and still more preferably 100% by mass) with respect to total resin components included in the transparent film, is more preferable.

In addition, the thickness of the above-described resin layer is not particularly limited, but is preferably 50 μm to 150 μm.

As the transparent film, a commercially available product may be used, and examples of the commercially available product include ACRYPLEN (registered trademark) HBS010 (acrylic resin film, manufactured by Mitsubishi Chemical Corporation.), and TECHNOLLOY (registered trademark) S001G (acrylic resin film, manufactured by Sumitomo Chemical Co., Ltd.), C000 (polycarbonate resin film, manufactured by Sumitomo Chemical Co., Ltd.), and C001 (acrylic resin/polycarbonate resin laminated film, manufactured by Sumitomo Chemical Co., Ltd.).

—Formation of Resin Layer—

The method for forming the resin layer is not particularly limited, and preferred examples thereof include a method of laminating a transparent film on the above-described colored layer.

As a device used in a case of laminating the transparent film, a known laminator such as a laminator, a vacuum laminator, and an auto-cut laminator capable of improving productivity can be used.

It is preferable that the laminator is equipped with any heatable roller such as a rubber roller and can perform pressing and heating.

By heating from the laminator, at least one of the transparent film or the liquid crystal layer is partially melted, and it is possible to further enhance adhesiveness between the liquid crystal layer and the transparent film.

The temperature at which the transparent film is laminated may be determined according to the material of the transparent film, the melting temperature of the liquid crystal layer, and the like, but is a temperature that the temperature of the transparent film can be preferably 60° C. to 150° C., more preferably 65° C. to 130° C., and particularly preferably 70° C. to 100° C.

In addition, in a case of laminating the transparent film, a linear pressure between the transparent film and the liquid crystal layer is preferably 60 N/cm to 200 N/cm, more preferably 70 N/cm to 160 N/cm, and particularly preferably 80 N/cm to 120 N/cm.

<<Pressure Sensitive Adhesive Layer>>

From the viewpoint of easy attachment to other members (preferably, other molding members) and improvement of adhesiveness between layers, the decorative film for molding manufactured by the method for manufacturing a decorative film for molding according to the embodiment of the present disclosure may have a pressure sensitive adhesive layer.

The material of the pressure sensitive adhesive layer is not particularly limited and can be suitably selected depending on the purpose.

Examples thereof include a layer containing a known pressure sensitive adhesive or adhesive.

—Pressure Sensitive Adhesive—

Examples of the pressure sensitive adhesive include an acrylic pressure sensitive adhesive, a rubber-based pressure sensitive adhesive, and a silicone-based pressure sensitive adhesive. In addition, examples of the pressure sensitive adhesive include acrylic pressure sensitive adhesives, ultraviolet (UV) curable pressure sensitive adhesives, and silicone-based pressure sensitive adhesives described in Chapters 2 of “Characterization evaluation of release paper, release film, and adhesive tape, and control technique thereof”, 2004, Information Mechanism. The acrylic pressure sensitive adhesive refers to a pressure sensitive adhesive including a polymer ((meth)acrylicpolymer) of a (meth)acrylic monomer.

In a case of containing a pressure sensitive adhesive, the layer may further contain a viscosity imparting agent.

—Adhesive—

Examples of the adhesive include a urethane resin adhesive, a polyester adhesive, an acrylic resin adhesive, an ethylene vinyl acetate resin adhesive, a polyvinyl alcohol adhesive, a polyamide adhesive, and a silicone adhesive. From the viewpoint of higher adhesive force, a urethane resin adhesive or a silicone adhesive is preferable.

—Method for Forming Pressure Sensitive Adhesive Layer—

The method for forming the pressure sensitive adhesive layer is not particularly limited, and examples thereof include a method of laminating a protective film on which the pressure sensitive adhesive layer is formed, such that the pressure sensitive adhesive layer and the colored layer are in contact with each other, a method of laminating the pressure sensitive adhesive layer alone so as to contact with the colored layer, and a method of coating the colored layer with a composition including the above-described pressure sensitive adhesive or adhesive. Preferred examples of the laminating method or coating method include the same method as the above-described method of laminating the transparent film or the above-described coating method of the composition for forming the colored layer.

From the viewpoint of achieving both pressure sensitive adhesive force and handleability, the thickness of the pressure sensitive adhesive layer in the decorative film is preferably 5 μm to 100 μm.

<<Ultraviolet Absorbing Layer>>

From the viewpoint of light resistance, the decorative film for molding according to the embodiment of the present disclosure preferably has a ultraviolet (UV) absorbing layer, and more preferably has a ultraviolet absorbing layer at a position where the cured liquid crystal layer can be viewed through the ultraviolet absorbing layer.

The ultraviolet absorbing layer is preferably a layer including a ultraviolet absorber, and more preferably a layer including a ultraviolet absorber and a binder polymer.

As the ultraviolet absorber, a known ultraviolet absorber can be used without particular limitation, and the ultraviolet absorber may be an organic compound or an inorganic compound.

Examples of the ultraviolet absorber include triazine compounds, benzotriazole compounds, benzophenone compounds, salicylic acid compounds, and metal oxide particles. In addition, the ultraviolet absorber may be a polymer including an ultraviolet absorbing structure, and examples of the polymer including an ultraviolet absorbing structure include acrylic resins which include a monomer unit derived from an acrylic acid ester compound including at least a part of structures of a triazine compound, a benzotriazole compound, a benzophenone compound, a salicylic acid compound, and the like.

Examples of the metal oxide particles include titanium oxide particles, zinc oxide particles, and cerium oxide particles.

Examples of the binder polymer include polyolefins, acrylic resins, polyesters, fluororesins, siloxane resins, and polyurethanes.

The ultraviolet absorbing layer is formed by applying, to a surface base material, a coating solution for forming the ultraviolet absorbing layer, which contains each component included the above-described ultraviolet absorbing layer and a solvent as necessary, and drying the coating solution as necessary.

The thickness of the ultraviolet absorbing layer is not particularly limited, but from the viewpoint of light resistance and three-dimensional moldability, is preferably 0.01 μm 100 μm, more preferably 0.1 μm to 50 μm, and particularly preferably 0.5 μm to 20 μm.

<<Other Layers>>

The decorative film for molding manufactured by the method for manufacturing a decorative film for molding according to the embodiment of the present disclosure may have other layers in addition to the above-described layers.

Examples of the other layers include a reflective layer, a self-repairing layer, an antistatic layer, an antifouling layer, an anti-electromagnetic wave layer, and a conductive layer, which are known as a layer for a decorative film.

The other layers in the above-described decorative film for molding can be formed by known methods. Examples thereof include a method of applying a composition (composition for forming a layer) containing components included in these layers in a layered shape, and drying the composition.

—Cover Film—

For the purpose of preventing stains, and the like, the decorative film for molding manufactured by the method for manufacturing a decorative film for molding according to the embodiment of the present disclosure may have a cover film as an outermost layer.

As the cover film, any material having flexibility and good peelability can be used without particular limitation, and examples thereof include resin films such as a polyethylene film.

The method for attaching the cover film is not particularly limited, and examples thereof include a known attaching method, such as a method of laminating the cover film on the protective layer.

<<Preferred Layer Configuration of Decorative Film for Molding>>

The layer configuration of the decorative film for molding manufactured by the method for manufacturing a decorative film for molding according to the embodiment of the present disclosure is not particularly limited as long as the decorative film has the base material and a liquid crystal layer cured (also referred to as a “cured liquid crystal layer”), but preferred examples thereof include layer configurations described below. In each of the following layer configurations, it is preferable to be an aspect in which the outermost layer is viewed from the side of the layer described on the right side.

Layer configuration 1: cured liquid crystal layer/base material

Layer configuration 2: base material/cured liquid crystal layer

Layer configuration 3: base material/colored layer/cured liquid crystal layer

Layer configuration 4: colored layer/cured liquid crystal layer/base material

Layer configuration 5: colored layer/base material/cured liquid crystal layer/protective layer

Layer configuration 6: base material/colored layer/cured liquid crystal layer/protective layer

Layer configuration 7: colored layer/cured liquid crystal layer/base material/protective layer

Layer configuration 8: colored layer/base material/cured liquid crystal layer/colored layer (color filter layer)/protective layer

Layer configuration 9: colored layer/cured liquid crystal layer/base material/cured liquid crystal layer/protective layer

Layer configuration 10: colored layer/cured liquid crystal layer/base material/colored layer (color filter layer)/protective layer

Layer configuration 11: colored layer/cured liquid crystal layer/base material/cured liquid crystal layer/colored layer (color filter layer)/protective layer

Among these, from the viewpoint of durability, and viewpoint of suppressing change in reflectance and change in tint after molding, as the layer configuration in the decorative film for molding according to the embodiment of the present disclosure, the aspect of layer configuration 3 to layer configuration 11 is preferable, the aspect of layer configuration 4, layer configuration 5, or layer configuration 7 to layer configuration 11 is more preferable, the aspect of layer configuration 7 to layer configuration 11 is still more preferable, the aspect of layer configuration 10 or layer configuration 11 is particularly preferable, and the aspect of layer configuration 11 is most preferable.

In addition, as necessary, the decorative film for molding manufactured by the method for manufacturing a decorative film for molding according to the embodiment of the present disclosure preferably has the alignment layer on at least one of the top and bottom of the liquid crystal layer in each of the above-described layer configurations.

From the viewpoint of attachment to other members, in each of the layer configurations, it is preferable that the decorative film for molding manufactured by the method for manufacturing a decorative film for molding according to the embodiment of the present disclosure further has, as the outermost layer, the pressure sensitive adhesive layer on the side of the layer described on the left side.

From the viewpoint of light resistance, the decorative film for molding manufactured by the method for manufacturing a decorative film for molding according to the embodiment of the present disclosure preferably further has the ultraviolet absorbing layer. The position of the above-described ultraviolet absorbing layer is preferably a position where the above-described cured liquid crystal layer can be viewed through the above-described ultraviolet absorbing layer. In a case where the decorative film for molding has a protective layer, it is preferable to have the ultraviolet absorbing layer at any position between the protective layer and the cured liquid crystal layer.

(Molding Method)

The molding method according to the embodiment of the present disclosure is a molding method including a step of molding a decorative film for molding manufactured by the method for manufacturing a decorative film for molding according to the embodiment of the present disclosure or the decorative film for molding according to the embodiment of the present disclosure described later.

<Molding Step>

Since the above-described decorative film for molding has excellent moldability, the decorative film according to the embodiment of the present disclosure can be suitably used for manufacturing a molded product, and for example, it is particularly suitable for manufacturing a molded product by at least one molding selected from the group consisting of three-dimensional molding and insert molding.

Hereinafter, the method for producing (method for molding) a molded product will be described in detail by taking insert molding as an example.

In the insert molding, the molded product is obtained, for example, by previously disposing a decorative film for molding in a mold and injection-molding a base material resin into the mold. By this insert molding, a molded product in which the surface of the resin molded product is integrated with the decorative film for molding is obtained.

Hereinafter, one embodiment of the method for producing a molded product by insert molding will be described.

The method for producing a molded product includes a step of disposing a decorative film for molding in a mold for injection molding and closing the mold, a step of injecting a molten resin into the mold, and a step of taking out a molded product in a case where the injected resin has solidified.

The mold for injection molding (that is, molding mold) used for manufacturing the molded product includes a mold (that is, male mold) having a convex shape, and a mold (that is, female mold) having a concave shape corresponding with the convex shape, and after disposing the decorative film for molding on a molding surface which is an inner peripheral surface of the female mold, the mold is closed.

Here, before disposing the decorative film for molding in the molding mold, by molding (preforming) the decorative film for molding using the molding mold, it is also possible to apply a three-dimensional shape to the decorative film for molding in advance and supply the decorative film for molding to the molding mold.

In addition, in a case of disposing the decorative film for molding in the molding mold, it is necessary to align the decorative film for molding with the molding mold in a state of inserting the decorative film for molding into the molding mold.

As a method of aligning the decorative film for molding with the molding mold in a state of inserting the decorative film for molding into the molding mold, there is a method of inserting and holding a fixing pin of the male mold into an alignment hole of the female mold.

Here, in the female mold, the alignment hole is formed in advance at an end portion (a position where the three-dimensional shape is not formed after molding) of the decorative film for molding.

In addition, in the male mold, the fixing pin is formed in advance at a position to be fitted with the alignment hole.

In addition, as a method of aligning the decorative film for molding with the molding mold in a state of inserting the decorative film for molding into the molding mold, the following method can be used in addition to the method of inserting the fixing pin into the alignment hole.

Examples thereof include a method of fine-adjusting and aligning the decorative film for molding by driving on a transporting device side as a target to an alignment mark which is applied in advance to a position of the decorative film for molding where the three-dimensional shape is not formed after molding. In this method, the alignment mark is preferably recognized at two or more diagonal points in a case of viewing from a product portion of the injection-molded product (decorative molded article).

After aligning the decorative film for molding with the molding mold and closing the molding mold, a molten resin is injected into the molding mold in which the decorative film for molding has been inserted. In a case of injection, the molten resin is injected on a side of the above-described resin base material of the decorative film for molding.

The temperature of the molten resin injected into the molding mold is set depending on the physical properties of the used resin, and the like. For example, in a case where the used resin is an acrylic resin, the temperature of the molten resin is preferably in a range of 240° C. to 260° C.

For the purpose of suppressing abnormal deformation of the decorative film for molding due to heat and gas generated in a case of injecting the molten resin into the molding mold, a position of an inlet (injection port) of the male mold may be set according to the shape of the molding mold and the type of the molten resin.

After solidifying the molten resin which is injected into the molding mold into which the decorative film for molding has been inserted, the molding mold is opened, and an intermediate decorative molded article, in which the decorative film for molding is fixed to a molding base material which is a solidified molten resin, is taken out from the molding mold.

In the intermediate molded product, around a decorative part which will be the final product (molded product), a burr and a dummy portion of the molded product are integrated. Here, the dummy portion has an insertion hole formed by inserting the fixing pin in the above-described alignment.

Therefore, finishing is performed to remove the burr and the dummy portion from the intermediate molded product before the finishing, thereby obtaining a molded product.

In addition, suitable examples of the above-described molding include three-dimensional molding.

Suitable examples of the three-dimensional molding include heat molding, vacuum molding, pressure molding, and vacuum pressure molding.

The method of performing the vacuum molding is not particularly limited, but is preferably a method of performing three-dimensional molding in a heated state under vacuum.

The vacuum means a state in which an inside of a chamber is evacuated to a vacuum degree of 100 Pa or less.

It is sufficient that the temperature in a case of performing the three-dimensional molding is appropriately set depending on the used base material for molding, but the temperature is preferably in a temperature range of 60° C. or higher, more preferably in a temperature range of 80° C. or higher, and still more preferably in a temperature range of 100° C. or higher. The upper limit of the temperature in a case of performing the three-dimensional molding is preferably 200° C.

The temperature in a case of performing the three-dimensional molding means a temperature of the base material for molding supplied for the three-dimensional molding, and is measured by attaching a thermocouple to the surface of the base material for molding.

The above-described vacuum molding can be performed using a vacuum molding technique widely known in the molding field, and for example, the vacuum molding may be performed using Formech 508FS manufactured by NIHON SEIZUKI KOGYO CO., LTD.

<Step of Curing Protective Layer>

In a case where the decorative film for molding has the above-described protective layer, the molding method according to the embodiment of the present disclosure preferably includes a step of curing the protective layer in the above-described decorative film for molding.

The curing method in the curing step is not particularly limited, and may be selected according to the crosslinkable group of the above-described siloxane resin included in the protective layer, the presence or absence of the ethylenic unsaturated group of the above-described organic resin, and the above-described polymerization initiator. However, a method of curing the above-described protective layer with light or heat is preferable, and a method of curing the above-described protective layer with light is more preferable.

If possible, the exposure in the curing step may be performed from either side of the above-described decorative film for molding, but it is preferable to be performed from the side of the protective layer.

In addition, in a case where a cover film is provided as the outermost layer on the side of the protective layer, the exposure may be performed with a state in which the cover film is provided (before the cover film is peeled off). In a case of performing the exposure from the above-described cover film side, the total light transmittance of the above-described cover film is preferably 80% or more and more preferably 90% or more.

As the exposure method, for example, methods described in paragraphs 0035 to 0051 of JP2006-023696A can be also suitably used in the present disclosure.

As a light source for the exposure, any light source capable of irradiating light in a wavelength range in which the protective layer can be cured (for example, 365 nm or 405 nm) can be appropriately selected and used.

Specific examples thereof include an ultra-high pressure mercury lamp, a high pressure mercury lamp, and a metal halide lamp.

The exposure amount is not particularly limited and may be set appropriately, but is preferably 5 mJ/cm² to 2,000 mJ/cm² and more preferably 10 mJ/cm² to 1,000 mJ/cm².

In addition, in the curing step, in addition to the protective layer, the above-described colored layer may be cured simultaneously or sequentially as necessary.

In a case of exposing the above-described colored layer with light, the above-described colored layer preferably includes the polymerizable compound and the photopolymerization initiator. By exposing the colored layer including the polymerizable compound and the photopolymerization initiator, a cured colored layer can be obtained.

In the curing step, in a case where the protective layer is cured by heat, the heating temperature and heating time are not particularly limited, and may be appropriately selected depending on a thermal polymerization initiator and the like to be used. For example, the heating temperature is preferably 60° C. to 200° C., and the heating time is preferably 5 minutes to 2 hours. The heating unit is not particularly limited, and a known heating unit can be used. Examples thereof include a heater, an oven, a hot plate, an infrared lamp, and an infrared laser.

<Other Steps>

The molding method according to the embodiment of the present disclosure may include any other steps, for example, a step of attaching the above-described decorative film for molding to a member for molding, and as described above, a step of removing a burr from the molded product, a step of removing a dummy portion from the molded product, and the like, in addition to the above-described steps as desired.

The other steps are particularly limited, and can be performed by using a known unit and a known method.

(Decorative Film for Molding)

The decorative film for molding according to the embodiment of the present disclosure includes a cured liquid crystal layer, which is formed by curing a liquid crystal layer including a cholesteric liquid crystal compound and a photoisomerization compound, on a base material, in which the cured liquid crystal layer has a plurality of regions which are different from each other in terms of a photoisomerization proportion of the photoisomerization compound. The plurality of regions may be regions where the photoisomerization proportions are different even though the photoisomerization of the above-described photoisomerization compound has occurred, or the above-described photoisomerization compound may have a portion (region) where the above-described photoisomerization compound is photoisomerized and a portion (region) where the above-described photoisomerization proportion is not photoisomerized.

For example, in the decorative film for molding according to the embodiment of the present disclosure, at least two regions where the difference in wavelength of a maximum reflectance between the at least two regions is 50 nm or more. The difference in wavelength of a maximum reflectance between the regions is preferably 50 nm or more, more preferably 75 nm or more, still more preferably 100 nm or more, and particularly preferably 200 nm to 1,000 nm. The above-described difference in wavelength of a maximum reflectance is preferably a difference in wavelength of a maximum reflectance in a range of 380 nm to 1,500 nm.

In addition, the decorative film for molding according to the embodiment of the present disclosure is preferably the decorative film for molding manufactured by the method for manufacturing a decorative film for molding according to the embodiment of the present disclosure.

In addition, the decorative film for molding according to the embodiment of the present disclosure can be used for various purposes, and examples thereof include interior and exterior of automobiles, interior and exterior of electric appliances, packaging containers, housings of electric appliances, and covers of smartphones or tablets. Among these, the decorative film for molding according to the embodiment of the present disclosure is suitably used as a decorative film for molding, which is used for the interior and exterior of automobiles, or a decorative film for molding, which is used for decorating an electronic device, and is particularly suitably used as a decorative film for molding, which is used for the exterior of automobiles, or a decorative film for molding, which is used for decorating a housing panel of an electronic device.

A preferred aspect of the decorative film for molding according to the embodiment of the present disclosure is the same as the preferred aspect of the decorative film for molding manufactured by the method for manufacturing a decorative film for molding according to the embodiment of the present disclosure, except for the matters described below.

The above-described cured liquid crystal layer in the decorative film for molding according to the embodiment of the present disclosure is a layer formed by curing the above-described liquid crystal layer in the method for manufacturing a decorative film for molding according to the embodiment of the present disclosure, and for example, in a case where a polymerizable cholesteric liquid crystal compound is used as the above-described cholesteric liquid crystal compound, the above-described cured liquid crystal layer is a layer including a polymer obtained by polymerizing the cholesteric liquid crystal compound. In addition, in a case where a photoisomerization compound having a polymerizable group is used as the above-described photoisomerization compound, the above-described cured liquid crystal layer is a layer including a polymer obtained by polymerizing the photoisomerization compound having a polymerizable group.

In addition, in the above-described cured liquid crystal layer of the decorative film for molding according to the embodiment of the present disclosure, even in a case where a photoisomerization compound having, as a photoisomerization structure, a di or higher-substituted ethylenic unsaturated bond is used as the above-described photoisomerization compound, confirmation of the distinction of the photoisomerization proportion of the above-described photoisomerization compound, for example, confirmation of a portion where the above-described photoisomerization compound is photoisomerized and a portion where the above-described photoisomerization compound is not photoisomerized, can be performed by non-polymerized photoisomerization compound.

(Molded Product, and Automobile Exterior Plate and Electronic Device)

The molded product according to the embodiment of the present disclosure is a molded product obtained by molding the decorative film for molding according to the embodiment of the present disclosure.

In addition, the molded product according to the embodiment of the present disclosure is preferably a molded product obtained by molding the decorative film for molding manufactured by the method for manufacturing a decorative film for molding according to the embodiment of the present disclosure.

Furthermore, the molded product according to the embodiment of the present disclosure is preferably a molded product manufactured by the molding method according to the embodiment of the present disclosure.

The molded product according to the embodiment of the present disclosure includes a plurality of regions which are different from each other in terms of a photoisomerization proportion of the photoisomerization compound, and at least two regions where a difference in wavelength of a maximum reflectance between the at least two regions is 50 nm or more. The difference in wavelength of a maximum reflectance between the regions is preferably 50 nm or more, more preferably 75 nm or more, still more preferably 100 nm or more, and particularly preferably 200 nm to 1,000 nm. The above-described difference in wavelength of a maximum reflectance is preferably a difference in wavelength of a maximum reflectance in a range of 380 nm to 1,500 nm.

The automobile exterior plate according to the embodiment of the present disclosure includes the molded product according to the embodiment of the present disclosure. The electronic device according to the embodiment of the present disclosure includes the molded product according to the embodiment of the present disclosure.

The shapes of the molded product according to the embodiment of the present disclosure and the automobile exterior plate according to the embodiment of the present disclosure are not particularly limited, and may be any desired shape. The type of the electronic device according to the embodiment of the present disclosure is not particularly limited, and examples thereof include smartphones, mobile phones, and tablets.

In addition, the molded product according to the embodiment of the present disclosure may be a molded product obtained by molding only the shape of the decorative film for molding according to the embodiment of the present disclosure, or as described above, may be a molded product in which the decorative film for molding according to the embodiment of the present disclosure is insert-molded and integrated on the surface of the resin molded product.

The automobile exterior plate according to the embodiment of the present disclosure may have a known member used for the automobile exterior plate, in addition to the molded product according to the embodiment of the present disclosure.

The application of the molded product manufactured by the molding method according to the embodiment of the present disclosure, and the molded product according to the embodiment of the present disclosure is not particularly limited and can be used for various products, and particularly suitable examples thereof include interior and exterior of automobiles, interior and exterior of electric appliances, and packaging containers. Among these, the interior and exterior of automobiles or the decoration of electronic devices are preferable, and the exterior of automobiles or the housing panel of electronic devices are more preferable.

### EXAMPLES

Hereinafter, the present disclosure will be described in detail with reference to examples, but the present disclosure is not limited thereto. In the present examples, “%” and “part” respectively indicate “% by mass” and “part by mass” unless otherwise specified.

### Example 1

<Preparation of Base Material>

As a base material, TECHNOLLOY C003 (methacrylic resin/polycarbonate resin two-layer sheet having a thickness of 125 μm, manufactured by Sumika Acryl Co., Ltd.) was prepared.

<Formation of Liquid Crystal Alignment Layer>

A coating solution 1 for a liquid crystal alignment layer having the following composition was prepared.

—Composition of Coating Solution 1 for Forming Liquid Crystal Alignment Layer—
Modified polyvinyl alcohol having the following structure (compound 11): 10.00 parts by mass
Water: 55.00 parts by mass
Methanol: 35.00 parts by mass

The structure of the modified polyvinyl alcohol (compound 11) is shown below. The numbers at the lower right of each structural unit represent the molar ratio.

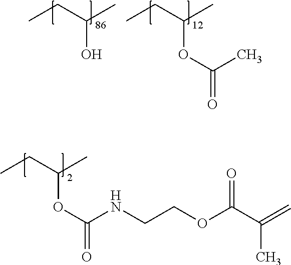

The surface of TECHNOLLOY C003 on the methacrylic resin side was subjected to corona treatment under the condition of 45 W·min/m².

Thereafter, the coating solution 1 for forming a liquid crystal alignment layer was applied to the surface subjected to the corona treatment with a wire bar (count #10), and dried at 100° C. for 2 minutes to obtain a laminate with a liquid crystal alignment layer.

Next, The produced liquid crystal alignment layer was subjected to a rubbing treatment (rayon cloth, pressure: 0.1 kgf, rotation speed: 1,000 rpm, transporting speed: 10 m/min, number of times: 1 time) in a direction rotated counterclockwise by 3 with respect to a short side direction.

<Formation of Liquid Crystal Layer>

A coating solution 2 for forming a liquid crystal layer having the following composition was prepared.

—Composition of Coating Solution 2 for Forming Liquid Crystal Layer—
Liquid crystal compound 1 (compound 1): 3.02 parts by mass
Chiral agent 1 (LC756, a chiral agent having two acryloxy groups and having a liquid crystal structure, manufactured by BASF): 0.204 parts by mass
Chiral agent 2 (compound 3): 0.023 parts by mass
Photopolymerization initiator (KAYACURE DETX, 2,4-diethylthioxanthone, manufactured by Nippon Kayaku Co., Ltd.): 0.091 parts by mass
Surfactant (compound 5, 1% diluted solution in methyl ethyl ketone (MEK)): 0.97 parts by mass
Methyl ethyl ketone (solvent): 4.37 parts by mass
Cyclohexanone (solvent): 1.33 parts by mass

The structure of the liquid crystal compound 1 (compound 1) is shown below.

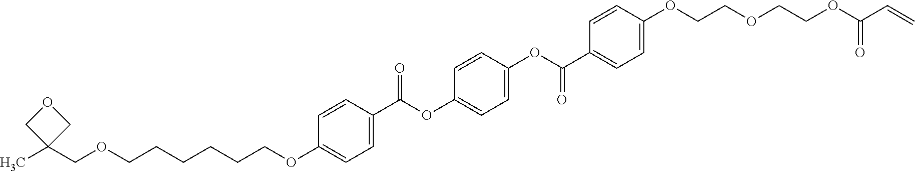 [SMILES: C=CC(=O)OCCOCCOc1ccc(C(=O)Oc2ccc(OC(=O)c3ccc(OCCCCCCOCC4(C)COC4)cc3)cc2)cc1]

The structure of the chiral agent 2 (compound 3) is shown below. In the following structural formula, Bu represents an n-butyl group.

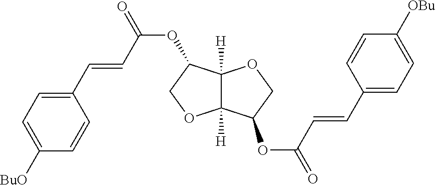

The structure of the surfactant (compound 5) is shown below.

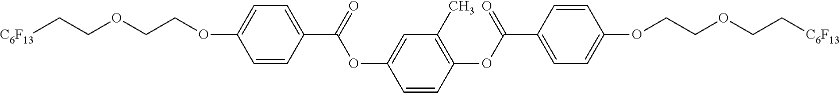

The coating solution 2 for forming a liquid crystal layer was applied to the liquid crystal alignment layer produced above using a wire bar (count #10), and then dried at 85° C. 2 minutes to form a liquid crystal layer having a thickness of 3 μm.

Next, the laminate with a liquid crystal layer was placed on a hot plate at 85° C., and for a portion not to be isomerized, an optical filter LV0510 manufactured by Asahi Spectra Co., Ltd. was used to block light of at least 311 nm. In addition, for a portion to be isomerized, an optical filter SH0350 manufactured by Asahi Spectra Co., Ltd. was used to cut light having a wavelength of 290 nm or less and light having a wavelength of 350 nm or more, and an isomerization treatment was performed by irradiating the portion to be isomerized of the liquid crystal layer with light of a metal halide lamp (MAL625NAL manufactured by GS Yuasa International Ltd.) in an exposure amount of 250 mJ/cm². Since the portion not to be isomerized is blocked from light of at least 311 nm, the portion is not isomerized.

Furthermore, the liquid crystal layer was cured by irradiating the liquid crystal layer with light of the metal halide lamp (MAL625NAL manufactured by GS Yuasa International Ltd.) in an exposure amount of 30 mJ/cm² on a hot plate at 85° C. under a low oxygen atmosphere (oxygen concentration: 1,000 ppm or less), thereby obtaining a laminate (decorative film for molding) with a liquid crystal layer having an isomerized portion and a non-isomerized portion.

<Evaluation of Laminate (Decorative Film for Molding) with Liquid Crystal Layer>

—Crosslinking Density—

The crosslinking density was evaluated using FT/IR-4000 manufactured by JASCO Corporation.

A liquid crystal alignment layer and a liquid crystal layer were formed on a silicon wafer SiD-4 manufactured by Canosis Co., Ltd by the above-described procedure.

The reaction consumption rate of C═C double bond (ethylenic unsaturated bond) is estimated by the following expression, and the equivalent amount (mol/L) of the C═C double bond of the liquid crystal compound included in the liquid crystal layer is calculated from the amount of the formulation added and multiplied by the reaction consumption rate. The result is defined as the crosslinking density of the ethylenic unsaturated bond in the liquid crystal layer.

Reaction consumption rate=(peak intensity derived from C═C double bond before curing−peak intensity derived from C═C double bond after curing)/peak intensity derived from C═C double bond before curing

—Reflection Characteristics Evaluation—

The reflection characteristics were evaluated using a spectrophotometer V-670 manufactured by JASCO Corporation.

A black PET (manufactured by TOMOEGAWA CO., LTD., product name: “KUKKIRI MIERU”) was attached to a surface of the laminate with a liquid crystal layer produced on TECHNOLLOY C003 by the above-described procedure, where the liquid crystal layer was not formed, and the reflection spectrum was measured with a surface on which the liquid crystal layer was formed as an incident surface.

The wavelengths at which the reflection spectra of the isomerized portion and the non-isomerized portion had the maximum values were calculated, and the difference therebetween was evaluated.

—Breaking Elongation—

The breaking elongation was evaluated using TENSILON RTF-1310 manufactured by A&D Company, Limited.

The laminate with a liquid crystal layer produced on TECHNOLLOY C003 by the above-described procedure was cut out to 100 mm in a longitudinal direction (MD direction) and 50 mm in a lateral direction (TD direction), and set in the apparatus with a chuck-to-chuck distance of 50 mm. Next, after heating at 150° C. for 3 minutes, the laminate was stretched under a condition of a tensile speed of 10 mm/min. The elongation at which the laminate was visually cracked during stretching was defined as the breaking elongation. As the breaking elongation is larger, the moldability is excellent. The evaluation standard is shown below.

A: breaking elongation was 150% or more.

B: breaking elongation was 120% or more and less than 150%.

C: breaking elongation was 100% or more and less than 120%.

D: breaking elongation was less than 100%.

<Formation of Colored Layer>

Nax REAL Super Black paint manufactured by NIPPONPAINT Co., Ltd. was applied to the liquid crystal layer of the above-described laminate with a liquid crystal layer using a wire bar (count #20), and dried at 100° C. for 2 minutes to obtain a laminate with a colored layer having a thickness of 10

<Formation of Ultraviolet (UV) Absorbing Layer>

A coating solution 3 for forming a UV absorbing layer having the following composition was prepared.

—Composition of Coating Solution 3 for Forming UV Absorbing Layer—
Ion exchange water: 2.42 parts by mass
Epocros WS-700 (oxazoline group-containing water-soluble polymer, manufactured by NIPPON SHOKUBAI CO., LTD.): 12.03 parts by mass
Tinuvin 479DW (triazine-based ultraviolet absorber, manufactured by BASF): 6.80 parts by mass
Diammonium hydrogen phosphate (diluted with 35% ion exchange water): 3.09 parts by mass
Arrowbase SE-1013N (olefin resin aqueous emulsion, manufactured by UNITIKA LTD.): 74.44 parts by mass
Fluorine-based surfactant (sodium=bis(3,3,4,4,5,5,6,6,6-nonafluorohexyl)=2-sulfonitoxysuccinate, manufactured by FUJIFILM Fine Chemicals Co., Ltd., 2% water dilution): 1.21 parts by mass

The surface of the laminate with a colored layer, on which the colored layer was not formed, was subjected to corona treatment under the condition of 45 W·min/m².

Thereafter, the coating solution 3 for forming a UV absorbing layer was applied to the surface subjected to the corona treatment with a wire bar (count #20), and dried at 100° C. for 2 minutes to obtain a laminate with a UV absorbing layer having a thickness of 6.6 μm.

<Formation of Protective Layer>

A coating solution 5 for forming a protective layer having the following composition was prepared.

—Composition of Coating Solution 5 for Forming Protective Layer—

The following materials were stirred at 25° C. for 24 hours to obtain a hydrolyzate 4 of an acrylate-modified siloxane oligomer.
Acryloyloxypropyltrimethoxysilane (manufactured by Shin-Etsu Chemical Co., Ltd.): 15.0 parts by mass
Methyltrimethoxysilane (manufactured by Shin-Etsu Chemical Co., Ltd.): 6.0 parts by mass
Ethanol (manufactured by FUJIFILM Wako Pure Chemical Corporation): 17.5 parts by mass
Acetic acid (manufactured by FUJIFILM Wako Pure Chemical Corporation): 3.6 parts by mass
Ion exchange water: 11.7 parts by mass

Next, the following components were stirred at 25° C. for 24 hours to obtain a coating solution 5 for forming a protective layer.
Hydrolyzate 4: 8.0 parts by mass
Ethanol: 8.0 parts by mass
Acrylate-modified acrylic resin A (Mn=20,000): 11.0 parts by mass
Acrylic resin (MMA/MAA=60/40, manufactured by Sigma-Aldrich Co. LLC, Mn=32,000): 11.7 parts by mass
IRGACURE 127 (a-hydroxyacetophenone compound, manufactured by BASF): 0.1 parts by mass
F-553 (fluorine-based surfactant manufactured by DIC Corporation): 0.02 parts by mass

<Synthesis of Acrylate-Modified Acrylic Resin A>

75 g of methyl methacrylate and 88 g of glycidyl methacrylate were copolymerized with each other using V-601 (2,2′-azobis(isobutyric acid) dimethyl, manufactured by FUJIFILM Wako Pure Chemical Corporation). 50 g of the obtained polymer was reacted with 192 g of acrylic acid in the presence of tetraethylammonium chloride to obtain an acrylate-modified acrylic resin A. The weight-average molecular weight thereof was 120,000. The acrylate functional amount (amount of a structural unit having an acryloxy group formed by reacting acrylic acid with a structural unit derived from glycidyl methacrylate with respect to all resins) was 30% by mass.

Next, the coating solution 5 for forming a protective layer was applied to the surface of the above-described laminate with a UV absorbing layer, on which the UV absorbing layer was formed, with a wire bar (count #20), and dried at 120° C. for 2 minutes to obtain a laminate with a protective layer having a thickness of 10 μm.

<Formation of Pessure Sensitive Adhesive Layer>

After peeling off a protective film on one side of a pressure sensitive adhesive sheet (G25, thickness: 25 μm, manufactured by Nichiei Kako Co., Ltd.) having protective films on both sides, the pressure sensitive adhesive sheet was laminated on the surface of the above-described laminate with a protective layer, on which the colored layer was formed, with a surface from which a temporary support was peeled off (temperature: 30° C., linear pressure: 100 N/cm, transporting speed: 0.1 m/min), thereby obtaining a decorative film for molding. The protective film on the other side of the pressure sensitive adhesive sheet was not peeled off. As described above, a decorative film for molding having a protective film, a pressure sensitive adhesive layer, a colored layer, a liquid crystal layer, a liquid crystal alignment layer, a base material, a UV absorbing layer, and a protective layer in this order was obtained.

<Formation of Molded Product>

Assuming an emblem of an automobile, a three-dimensional molded product was produced for a columnar member having a diameter of 10 cm and a height of 5 mm.

After peeling off the protective film of the pressure sensitive adhesive sheet produced in the above-descried procedure, a molded product was formed by vacuum molding at a heating temperature of 150° C. using a TOM molding machine NGF0406 manufactured by Fu-se Vacuum Forming.

After molding, the molded product was cured by irradiating the surface on which the protective layer was formed with light of the metal halide lamp (MAL625NAL manufactured by GS Yuasa International Ltd.) in an exposure amount of 1,000 mJ/cm² under a low oxygen atmosphere (oxygen concentration: 1,000 ppm or less).

<Evaluation of Color Uniformity (Visibility)>

With regard to the molded product produced by the above-described procedure, a portion having a stretching ratio described in the table of Examples was cut out, and the difference in tint as compared with an unstretched portion was visually evaluated for appearance. The standard for the evaluation results are as follows. A to C are preferable, A or B is more preferable, and A is particularly preferable.

A: compared with a portion where the stretching ratio was 0%, no change in tint could be viewed.

B: compared with a portion where the stretching ratio was 0%, a slight change in tint could be viewed.

C: compared with a portion where the stretching ratio was 0%, a little change in tint could be viewed.

D: compared with a portion where the stretching ratio was 0%, a strong change in tint could be viewed.

The stretching ratio at each portion of the molded product was calculated by the following procedure.

—Procedure for Calculating Stretching Ratio—

Using Mackee-care ultrafine (line width: 0.3 mm, manufactured by ZEBRA CO., LTD.), lines were drawn in a grid pattern on a surface of TECHNOLLOY C003 cut out to A4 size on the polycarbonate resin side to produce, on the entire surface of the base material, squares having a side of 5 mm. Next, vacuum molding was performed in the same procedure as the above-described molded product to form a molded product. Next, the stretching ratio was calculated by the following expression.

Stretching ratio=(square are after molding−square area before molding)/square area before molding

A case where the stretching ratio is 100% means that the area after molding is twice as large as that before molding, and a case where is 200% means that the area after molding is three times as large as that before molding.

<Evaluation of Reflectance after Molding>

With regard to the molded article produced by the above-described procedure, a portion having a stretching ratio described in Table 1 was cut out, and the reflection characteristics were measured using a spectrophotometer V-670 manufactured by JASCO Corporation, with a surface on which the liquid crystal layer was not formed as an incident surface. The wavelengths at which the reflection spectra of the unstretched portion and a portion of the above-described stretching ratio had the maximum values were calculated, and the difference therebetween was evaluated. As the difference is smaller, the color uniformity after molding is better.

A: value of the difference was 0 nm to 20 nm.

B: value of the difference was more than 20 nm and 40 nm or less.

C: value of the difference was more than 40 nm and 60 nm or less.

D: value of the difference was more than 60 nm.

### Examples 2 to 19 and Comparative Examples 1 and 2

A decorative film for molding and a molded product were produced in the same manner as in Example 1, except that the type of the base material, composition of each layer, the presence or absence of formation of each layer, and the conditions of the liquid crystal layer forming step, photoisomerization step, and curing step were changed as shown in Tables 1 and 2.

The decorative film for molding of each of Examples and Comparative Examples was a film in which each layer was arranged in the order shown in Tables 1 and 2 (however, the description of the protective film and the pressure sensitive adhesive layer is omitted in the tables), and was a decorative film for molding, which was viewed from the protective layer side. For example, the decorative films for molding of Examples 2 to 17 and Comparative Examples 1 and 2 are films in which the liquid crystal alignment layer and the liquid crystal layer are formed on the surface of the base material opposite to the viewing side, and the decorative films for molding of Examples 18 and 19 are films in which the liquid crystal alignment layer and the liquid crystal layer are formed between the protective layer and the base material.

In addition, the evaluations were performed by the same method as in Example 1. The evaluation results are summarized in Table 3.

TABLE 1

| | | | | | | | | | | | | | | | Liquid | | | | | | | |
|---|---|---|---|---|---|---|---|---|---|---|---|---|---|---|---|---|---|---|---|---|---|---|
| | | | Ultra- | | | Liquid | Liquid crystal layer | | | | | | | | crystal layer | | Photoisomerization | | | | | |
| | | | violet | | | crystal | Liquid | | | | Photo- | | | | forming step | | step | | | Curing step | | |
| | | | ab- | | | align- | crystal | Chiral agent | | | polymer- | | Layer | | Tem- | | | Tem- | Ex- | | Tem- | Ex- |
| | | Protective | sorbing | Colored | Base | ment | com- | Chiral | Chiral | 1/ | ization | Sur- | thick- | Colored | per- | | | per- | posure | | per- | posure |
| | | layer | layer | layer | material | layer | pound | agent 1 | agent 2 | (1 + 2) | initiator | factant | ness | layer | ature | Time | Mask | ature | amount | Mask | ature | amount |
| Ex- | 1 | Siloxane | Olefin | | C003 | Com- | Com- | LC756 | Com- | 90% | DETX | Com- | 3 μm | Nax | 85° C. | 2 | 311 | 85° C. | 250 mJ | None | 85° C. | 30 mJ |
| ample | | resin/acrylic | resin | | | pound | pound | | pound | | | pound | | REAL | | minutes | nm | | | | | |
| | | resin-mixed | | | | 11 | 1 | | 3 | | | 5 | | | | | | | | | | |
| | | layer | | | | | | | | | | | | | | | | | | | | |
| | 2 | Siloxane | Olefin | | C003 | Com- | Com- | LC756 | Com- | 70% | DETX | Com- | 3 μm | Nax | 85° C. | 2 | 311 | 85° C. | 250 mJ | None | 85° C. | 30 mJ |
| | | resin/acrylic | resin | | | pound | pound | | pound | | | pound | | REAL | | minutes | nm | | | | | |
| | | resin-mixed | | | | 11 | 1 | | 3 | | | 5 | | | | | | | | | | |
| | | layer | | | | | | | | | | | | | | | | | | | | |
| | 3 | Siloxane | Olefin | | C003 | Com- | Com- | LC756 | Com- | 50% | DETX | Com- | 3 μm | Nax | 85° C. | 2 | 311 | 85° C. | 250 mJ | None | 85° C. | 30 mJ |
| | | resin/acrylic | resin | | | pound | pound | | pound | | | pound | | REAL | | minutes | nm | | | | | |
| | | resin-mixed | | | | 11 | 1 | | 3 | | | 5 | | | | | | | | | | |
| | | layer | | | | | | | | | | | | | | | | | | | | |
| | 4 | Siloxane | Olefin | | C003 | Com- | Com- | LC756 | Com- | 50% | DETX | Com- | 3 μm | Nax | 85° C. | 2 | 311 | 85° C. | 250 mJ | None | 85° C. | 100 mJ |
| | | resin/acrylic | resin | | | pound | pound | | pound | | | pound | | REAL | | minutes | nm | | | | | |
| | | resin-mixed | | | | 11 | 1 | | 3 | | | 5 | | | | | | | | | | |
| | | layer | | | | | | | | | | | | | | | | | | | | |
| | 5 | Siloxane | Olefin | | C003 | Com- | Com- | LC756 | Com- | 30% | DETX | Com- | 3 μm | Nax | 85° C. | 2 | 311 | 85° C. | 250 mJ | None | 85° C. | 100 mJ |
| | | resin/acrylic | resin | | | pound | pound | | pound | | | pound | | REAL | | minutes | nm | | | | | |
| | | resin-mixed | | | | 11 | 1 | | 3 | | | | | | | | | | | | | |
| | | layer | | | | | | | | | | 5 | | | | | | | | | | |
| | 6 | Siloxane | Olefin | | C003 | Com- | Com- | LC756 | Com- | 30% | DETX | Com- | 3 μm | Nax | 85° C. | 2 | 311 | 85° C. | 250 mJ | None | 85° C. | 100 mJ |
| | | resin/acrylic | resin | | | pound | pound | | pound | | | pound | | REAL | | minutes | nm | | | | | |
| | | resin-mixed | | | | 11 | 1 | | 3 | | | 5 | | | | | | | | | | |
| | | layer | | | | | | | | | | | | | | | | | | | | |
| | 7 | Siloxane | Olefin | | C003 | Com- | Com- | LC756 | Com- | 30% | DETX | Com- | 3 μm | Nax | 85° C. | 2 | 311 | 85° C. | 250 mJ | None | 85° C. | 100 mJ |
| | | resin/acrylic | resin | | | pound | pound | | pound | | | pound | | REAL | | minutes | nm | | | | | |
| | | resin-mixed | | | | 11 | 1 | | 3 | | | 5 | | | | | | | | | | |
| | | layer | | | | | | | | | | | | | | | | | | | | |
| | 8 | Siloxane | Olefin | | C003 | Com- | Com- | LC756 | Com- | 20% | DETX | Com- | 3 μm | Nax | 85° C. | 2 | 311 | 85° C. | 250 mJ | None | 85° C. | 100 mJ |
| | | resin/acrylic | resin | | | pound | pound | | pound | | | pound | | REAL | | minutes | nm | | | | | |
| | | resin-mixed | | | | 11 | 1 | | 3 | | | 5 | | | | | | | | | | |
| | | layer | | | | | | | | | | | | | | | | | | | | |
| | | Siloxane | | | | | | | | | | | | | | | | | | | | |
| | | resin/acrylic | | | | | | | | | | | | | | | | | | | | |
| | | resin-mixed | | | | | | | | | | | | | | | | | | | | |
| | | layer | | | | | | | | | | | | | | | | | | | | |
| | 9 | Siloxane | Olefin | | C003 | Com- | Com- | LC756 | Com- | 50% | DETX | Com- | 3 μm | Nax | 85° C. | 2 | 311 | 85° C. | 250 mJ | None | 85° C. | 100 mJ |
| | | resin/acrylic | resin | | | pound | pound | | pound | | | pound | | REAL | | minutes | nm | | | | | |
| | | resin-mixed | | | | 11 | 1 | | 3 | | | 5 | | | | | | | | | | |
| | | layer | | | | | | | | | | | | | | | | | | | | |
| | 10 | Siloxane | Olefin | | C003 | Com- | Com- | LC756 | Com- | 50% | DETX | Com- | 3 μm | Nax | 85° C. | 2 | 311 | 85° C. | 250 mJ | None | 85° C. | 30 mJ |
| | | resin/acrylic | resin | | | pound | pound | | pound | | | pound | | REAL | | minutes | nm | | | | | |
| | | resin-mixed | | | | 11 | 1 | | 4 | | | 5 | | | | | | | | | | |
| | | layer | | | | | | | | | | | | | | | | | | | | |
| Ex- | 11 | Siloxane | Olefin | | C003 | Com- | Com- | LC756 | Com- | 50% | DETX | Com- | 3 μm | Nax | 85° C. | 2 | 311 | 85° C. | 250 mJ | None | 85° C. | 30 mJ |
| ample | | resin/acrylic | resin | | | pound | pound | | pound | | | pound | | REAL | | minutes | nm | | | | | |
| | | resin-mixed | | | | 11 | 1 | | 3 | | | 5 | | | | | | | | | | |
| | | layer | | | | | | | | | | | | | | | | | | | | |
| | 12 | Siloxane | Olefin | | C003 | Com- | Com- | LC756 | Com- | 50% | DETX | Com- | 3 μm | Nax | 85° C. | 2 | 311 | 60° C. | 250 mJ | None | 60° C. | 30 mJ |
| | | resin/acrylic | resin | | | pound | pound | | pound | | | pound | | REAL | | minutes | nm | | | | | |
| | | resin-mixed | | | | 11 | 1 | | 3 | | | 5 | | | | | | | | | | |
| | | layer | | | | | | | | | | | | | | | | | | | | |
| | 13 | Siloxane | Olefin | | S001 | Com- | Com- | LC756 | Com- | 50% | DETX | Com- | 3 μm | Nax | 85° C. | 2 | 311 | 85° C. | 250 mJ | None | 85° C. | 30 mJ |
| | | resin/acrylic | resin | | | pound | pound | | pound | | | pound | | REAL | | minutes | nm | | | | | |
| | | resin-mixed | | | | 11 | 1 | | 3 | | | 5 | | | | | | | | | | |
| | | layer | | | | | | | | | | | | | | | | | | | | |
| | 14 | Siloxane | Olefin | | C003 | Com- | Com- | LC756 | Com- | 50% | DETX | Com- | 3 μm | Nax | 85° C. | 2 | 311 | 85° C. | 250 mJ | None | 85° C. | 30 mJ |
| | | resin/acrylic | resin | | | pound | pound | | pound | | | pound | | REAL | | minutes | nm | | | | | |
| | | resin-mixed | | | | 11 | 1 | | 3 | | | 5 | | | | | | | | | | |
| | | layer | | | | | | | | | | | | | | | | | | | | |
| | 15 | Siloxane | Olefin | | C003 | Com- | Com- | LC756 | Com- | 50% | Irgacure | Com- | 3 μm | Nax | 85° C. | 2 | 311 | 85° C. | 250 mJ | None | 85° C. | 30 mJ |
| | | resin/acrylic | resin | | | pound | pound | | pound | | 184 | pound | | REAL | | minutes | nm | | | | | |
| | | resin-mixed | | | | 11 | 1 | | 3 | | | 5 | | | | | | | | | | |
| | | layer | | | | | | | | | | | | | | | | | | | | |
| | 16 | Siloxane | Olefin | | C003 | Com- | Com- | LC756 | Com- | 50% | DETX | Com- | 2.1 μm | Nax | 85° C. | 2 | 311 | 85° C. | 250 mJ | None | 85° C. | 30 mJ |
| | | resin/acrylic | resin | | | pound | pound | | pound | | | pound | | REAL | | minutes | nm | | | | | |
| | | resin-mixed | | | | 11 | 1 | | 3 | | | 5 | | | | | | | | | | |
| | | layer | | | | | | | | | | | | | | | | | | | | |
| | 17 | Siloxane | Olefin | | C003 | Com- | Com- | LC756 | Com- | 50% | DETX | Com- | 1.2 μm | Nax | 85° C. | 2 | 311 | 85° C. | 250 mJ | None | 85° C. | 30 mJ |
| | | resin/acrylic | resin | | | pound | pound | | pound | | | pound | | REAL | | minutes | nm | | | | | |
| | | resin-mixed | | | | 11 | 1 | | 3 | | | 5 | | | | | | | | | | |
| | | layer | | | | | | | | | | | | | | | | | | | | |
| Com- | 1 | Siloxane | Olefin | Nax | C003 | Com- | Com- | LC756 | Com- | 100% | DETX | Com- | 3 μm | Nax | 85° C. | 2 | | | | None | 85° C. | 100 mJ |
| para- | | resin/acrylic | resin | REAL | | pound | pound | | pound | | | pound | | REAL | | minutes | | | | | | |
| tive | | resin-mixed | | | | 11 | 1 | | 2 | | | 3 | | | | | | | | | | |
| Ex- | | layer | | | | | | | | | | | | | | | | | | | | |
| ample | 2 | Siloxane | Olefin | Nax | C003 | Com- | Com- | LC756 | Com- | 90% | DETX | Com- | 3 μm | Nax | 85° C. | 2 | | | | None | 85° C. | 30 mJ |
| | | resin/acrylic | resin | REAL | | pound | pound | | pound | | | pound | | REAL | | minutes | | | | | | |
| | | resin-mixed | | | | 11 | 1 | | 2 | | | 3 | | | | | | | | | | |
| | | layer | | | | | | | | | | | | | | | | | | | | |

TABLE 2

| | | | | Liquid crystal layer | | | | | | | Liquid | |
|---|---|---|---|---|---|---|---|---|---|---|---|---|
| | | | Ultra- | | Chiral agent | | | Photo- | | | crystal | |
| | | | violet | Liquid | Chiral | Chiral | Layer | polymer- | Sur- | Layer | align- | |
| | | Protective | absothing | crystal | agent | agent | 1/ | ization | fact- | thick- | ment | Colored |
| | | layer | layer | compound | 1 | 2 | (1+ 2) | initiator | ant | ness | layer | layer |
| Ex- | 18 | Siloxane | Olefin | Com- | LC756 | Com- | 50% | DETX | Com- | 3 μm | Com- | |
| ample | | resin/acrylic | resin | pound | | pound | | | pound | | pound | |
| | | resin-mixed | | 1 | | 3 | | | 5 | | 11 | |
| | | layer | | | | | | | | | | |
| | 19 | Siloxane | Olefin | Com- | LC756 | Com- | 50% | DETX | Com- | 3 μm | Com- | Nax |
| | | resin/acrylic | resin | pound | | pound | | | pound | | pound | REAL |
| | | resin-mixed | | 1 | | 3 | | | 5 | | 11 | |
| | | layer | | | | | | | | | | |
| | | | | | | | | Photo- | | | | |
| | | | | | Liquid | | | isomerization | | | | |
| | | | | | crystal layer | | | step | | Curing step | | |
| | | | | | forming step | | | | Ex- | | | Ex- |
| | | | Base | Colored | Tem- | | | Tem- | posure | | Tem- | posure |
| | | | material | layer | perature | Time | Mask | perature | amount | Mask | perature | amount |
| | Ex- | 18 | C003 | Nax | 85° C. | 2 | 311 | 85° C. | 250 mJ | None | 85° C. | 100 mJ |
| | ample | | | REAL | | minutes | nm | | | | | |
| | | 19 | C003 | | 85° C. | 2 | 311 | 85° C. | 250 mJ | None | 85° C. | 100 mJ |
| | | | | | | minutes | nm | | | | | |

TABLE 3

| | | Evaluation | | | | | | | | | | | |
|---|---|---|---|---|---|---|---|---|---|---|---|---|---|
| | | Cross- | Wavelength | | | | | | | Wavelength of | | | |
| | | linking | of maximum | | | | | Stretching | | maximum reflectance after | | | |
| | | density | reflectance (nm) | | | | | ratio of | | molding and after stretching (nm) | | | |
| | | of | | Non- | | | | molded | | | Non- | | |
| | | liquid | Iso- | iso- | | | | part | Color | Iso- | iso- | | |
| | | crystal | merized | merized | Differ- | Breaking | | to be | uniformity | merized | merized | | |
| | | layer | portion | portion | ence | elongation | | applied | (visibility) | portion | portion | Difference | |
| Example | 1 | 0.29 | 480 | 430 | 50 | C | 100% | 10% | B | 460 | 430 | B | 30 |
| | 2 | 0.25 | 510 | 430 | 80 | B | 130% | 25% | A | 440 | 430 | A | 10 |
| | 3 | 0.22 | 720 | 460 | 260 | A | 180% | 80% | A | 450 | 460 | A | 10 |
| | 4 | 0.46 | 720 | 430 | 260 | A | 160% | 80% | A | 450 | 430 | A | 10 |
| | 5 | 0.40 | 1040 | 440 | 600 | A | 200% | 180% | A | 440 | 440 | A | 0 |
| | 6 | 0.40 | 1040 | 440 | 600 | A | 200% | 170% | B | 465 | 440 | B | 25 |
| | 7 | 0.40 | 1040 | 440 | 600 | A | 200% | 160% | C | 490 | 440 | C | 50 |
| | 8 | 0.36 | 1200 | 440 | 760 | A | 250% | 210% | C | 490 | 440 | C | 50 |
| | 9 | 0.43 | 710 | 460 | 260 | A | 160% | 80% | A | 440 | 460 | A | 20 |
| | 10 | 0.22 | 720 | 460 | 260 | A | 180% | 80% | A | 450 | 460 | A | 10 |
| | 11 | 0.22 | 720 | 460 | 260 | A | 180% | 80% | A | 450 | 460 | A | 10 |
| | 12 | 0.18 | 720 | 440 | 260 | A | 200% | 80% | A | 460 | 440 | A | 20 |
| | 13 | 0.22 | 720 | 440 | 260 | A | 180% | 80% | A | 450 | 460 | A | 10 |
| | 14 | 0.22 | 720 | 440 | 260 | A | 180% | 80% | A | 450 | 460 | A | 10 |
| | 15 | 0.31 | 730 | 440 | 270 | A | 150% | 80% | A | 460 | 460 | A | 0 |
| | 16 | 0.32 | 730 | 440 | 270 | A | 185% | 80% | A | 460 | 460 | A | 0 |
| | 17 | 0.34 | 730 | 440 | 270 | A | 190% | 80% | A | 460 | 460 | A | 0 |
| | 18 | 0.34 | 730 | 440 | 270 | A | 190% | 80% | A | 460 | 460 | A | 0 |
| | 19 | 0.34 | 730 | 440 | 270 | A | 190% | 80% | A | 460 | 460 | A | 0 |
| Com- | 1 | 0.30 | | 420 | | D | 80% | 10% | D | | 390 | | |
| parative | 2 | 0.29 | | 430 | | C | 100% | 10% | D | | 395 | | |
| Example | | | | | | | | | | | | | |

Each numerical value in the column of “1/(1+2)” in Tables 1 and 2 represents the content ratio (% by mass) of the chiral agent 1 to the total mass of the chiral agent 1 and the chiral agent 2.

The abbreviations shown in Table 1 and Table 2, other than those described above, are shown below.

TECHNOLLOY 5001: methacrylic resin sheet having a thickness of 125 manufactured by Sumika Acryl Co., Ltd.

Compound 2: compound shown below

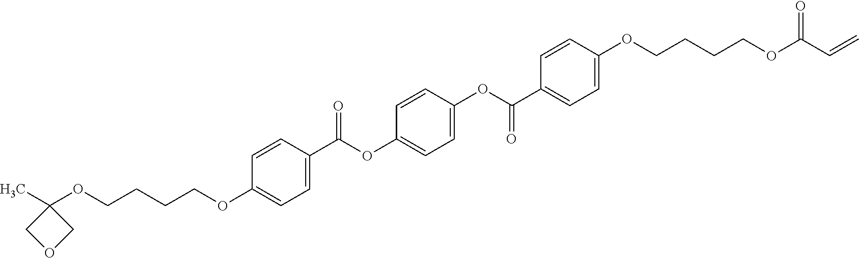 [SMILES: C=CC(=O)OCCCCOc1ccc(C(=O)Oc2ccc(OC(=O)c3ccc(OCCCCOC4(C)COC4)cc3)cc2)cc1]

Compound 4: compound shown below; in the following compound, Bu represents an n-butyl group.

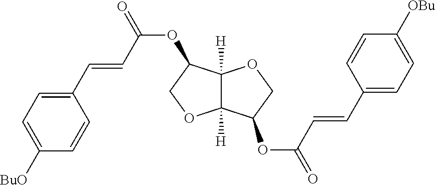

Compound 6: compound shown below

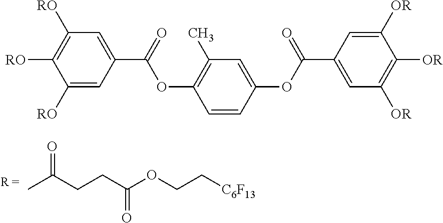

As shown in Tables 1 to 3, compared with the decorative films for molding of Comparative Examples 1 and 2, the decorative films for molding of Examples 1 to 19 had a smaller change in tint after molding.

In addition, the decorative films for molding of Examples 1 to 19 were also excellent in moldability.

The decorative film for molding according to the embodiment of the present disclosure has a small change in tint after molding regardless of the stretching ratio during the molding. On the other hand, by forming patterns such as a design on the decorative film for molding in advance, it is possible to express various patterns, gradations, and other design with reflection colors, and it is also possible to provide a decorative film having excellent designability. The pattern such as a design may be formed by, for example, changing the isomerization proportion of each region in the isomerization treatment. Hereinafter, Examples 20 to 22 show actual examples of decorative films in which patterns are formed.

### Example 20

<Formation of Liquid Crystal Layer>

A coating solution 6 for forming a liquid crystal layer having the following composition was prepared.

—Composition of Coating Solution 6 for Forming Liquid Crystal Layer—
Liquid crystal compound 1 (compound 1) described above: 2.42 parts by mass
Liquid crystal compound 2 (compound 7): 0.30 parts by weight
Liquid crystal compound 3 (compound 8): 0.30 parts by mass
Chiral agent 1 (LC756, a chiral agent having two acryloxy groups and having a liquid crystal structure, manufactured by BASF) described above: 0.204 parts by mass
Chiral agent 2 (compound 3) described above: 0.023 parts by mass
Photopolymerization initiator (KAYACURE DETX, 2,4-diethylthioxanthone, manufactured by Nippon Kayaku Co., Ltd.): 0.091 parts by mass
Surfactant (compound 5, 1% diluted solution in methyl ethyl ketone (MEK)): 0.97 parts by mass
Methyl ethyl ketone (solvent): 4.37 parts by mass
Cyclohexanone (solvent): 1.33 parts by mass

The structure of the liquid crystal compound 2 (compound 7) is shown below.

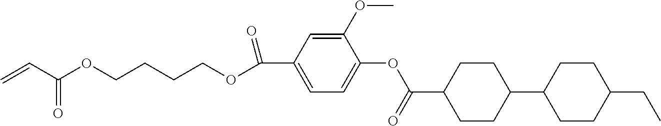 [SMILES: C=CC(=O)OCCCCOC(=O)c1ccc(OC(=O)C2CCC(C3CCC(CC)CC3)CC2)c(OC)c1]

The structure of the liquid crystal compound 3 (compound 8) is shown below.

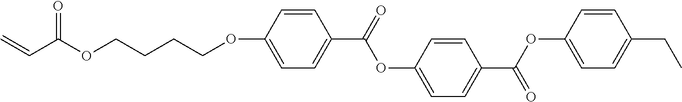 [SMILES: C=CC(=O)OCCCCOc1ccc(C(=O)Oc2ccc(C(=O)Oc3ccc(CC)cc3)cc2)cc1]

<Production of Pattern Mask>

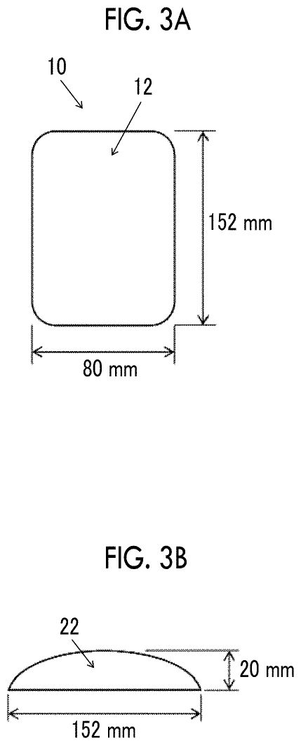

A mask film having a black gradation mask pattern shown in FIG. 1 was produced on a highly transparent polyester film COSMOSHINE A4300 (manufactured by TOYOBO Co., Ltd., thickness: 50 μm) using a UV inkjet printer (Acuity 1600, manufactured by FUJIFILM Corporation, resolution: 600 dpi). Thereafter, a decorative film for molding was produced in the same manner as in Example 10, except that the coating solution 6 for forming a liquid crystal layer was used as the coating solution for forming a liquid crystal layer, and instead of the optical filter LV0510 manufactured by Asahi Spectra Co., Ltd. and the optical filter SH0350 manufactured by Asahi Spectra Co., Ltd., the above-described mask film having the mask pattern shown in FIG. 1 was used for exposure in the isomerization treatment. By using such a mask film, the photoisomerization proportion in the liquid crystal layer continuously fluctuates depending on the region. In FIG. 1, the photoisomerization proportion in the upper region is lowered due to the shielding of exposure light by the mask film. The obtained decorative film for molding was molded in the housing shown in FIGS. 3A and 3B assuming a rear housing panel of a smartphone, thereby producing a decorative panel. In FIGS. 3A and 3B, a reference 10 represents a housing panel, a reference 12 represents a rear surface of the housing panel, and a reference 22 represents a side surface (bottom side surface) of the housing panel 10 in a case of being viewed from the lower side in FIG. 3A.

The obtained decorative panel exhibited a vivid reflection color of blue to red in a gradation tone, and had excellent designability.

### Example 21

A decorative panel was produced in the same manner as in Example 20, except that, instead of the mask film having the mask pattern shown in FIG. 1, a mask film having the mask pattern shown in FIG. 2 was used for exposure in the isomerization treatment. In FIG. 2, the photoisomerization proportion in the black region is lowered due to the shielding of exposure light by the mask film. The obtained decorative panel had a vivid design in which regions of different reflection colors consisting of a region exhibiting blue reflection and a region exhibiting red reflection were included.

### Example 22

A decorative panel was produced in the same manner as in Example 20, except that, in the colored layer, Nax REAL 320 White paint manufactured by NIPPONPAINT Co., Ltd. was used instead of Nax REAL Super Black paint manufactured by NIPPONPAINT Co., Ltd. In a case where the obtained decorative panel was viewed, a vivid reflection color of blue to red in a gradation tone was viewed, but depending on the angle, a gradation of complementary colors (yellow to cyan) reflected on the white layer (colored layer) was viewed. As a result, the decorative panel had a unique design.

The disclosure of JP2018-234493 filed on December 14, 2018 is incorporated in the present specification by reference.

All documents, patent applications, and technical standards described in the present specification are incorporated herein by reference to the same extent as in a case of being specifically and individually noted that individual documents, patent applications, and technical standards are incorporated by reference.

What is claimed is:

1. A method for manufacturing a decorative film for molding, comprising, in the following order:
forming, on a base material, a liquid crystal layer comprising a cholesteric liquid crystal compound and a photoisomerization compound;
photoisomerizing the liquid crystal layer; and
curing the liquid crystal layer.

2. The method for manufacturing a decorative film for molding according to claim 1,
wherein, in the photoisomerization, a part of a region of the liquid crystal layer is isomerized.

3. The method for manufacturing a decorative film for molding according to claim 2,
wherein a difference between a wavelength of a maximum reflectance of a region where the photoisomerization is most advanced in the manufactured decorative film for molding and a wavelength of a maximum reflectance of a region where the photoisomerization is least advanced in the manufactured decorative film for molding is 50 nm or more.

4. The method for manufacturing a decorative film for molding according to claim 2,
wherein, at least a part of a region of the manufactured decorative film for molding is stretched to a stretching ratio of 10% to 250% in terms of area ratio, and a difference between a wavelength of a maximum reflectance of the stretched region and a wavelength of a maximum reflectance of the region where the photoisomerization is least advanced is less than 50 nm.

5. The method for manufacturing a decorative film for molding according to claim 1,
wherein the manufactured decorative film for molding comprises a region where a wavelength of a maximum reflectance is within a range of 380 nm to 780 nm.

6. The method for manufacturing a decorative film for molding according to claim 1,
wherein the cholesteric liquid crystal compound in the liquid crystal layer has a radically polymerizable group.

7. The method for manufacturing a decorative film for molding according to claim 6,
wherein the cured liquid crystal layer in the manufactured decorative film for molding has a density of crosslinking formed from the radically polymerizable group of 0.15 mol/L to 0.5 mol/L.

8. The method for manufacturing a decorative film for molding according to claim 1,
wherein a decorative film for molding, which is used for an exterior of an automobile, is manufactured.

9. The method for manufacturing a decorative film for molding according to claim 1,
wherein a decorative film for molding, which is used for decorating a housing panel of an electronic device, is manufactured.

10. A molding method comprising:
molding a decorative film for molding manufactured by the method for manufacturing a decorative film for molding according to claim 1.

11. A decorative film for molding comprising:
a cured liquid crystal layer, which is formed by curing a liquid crystal layer comprising a cholesteric liquid crystal compound and a photoisomerization compound, on a base material,
wherein the cured liquid crystal layer has a plurality of regions which are different from each other in terms of a photoisomerization proportion of the photoisomerization compound.

12. The decorative film for molding according to claim 11, comprising at least two regions, wherein a difference in wavelength of a maximum reflectance between the at least two regions is 50 nm or more.

13. The decorative film for molding according to claim 11,
wherein the decorative film for molding is a decorative film for molding used for an exterior of an automobile.

14. The decorative film for molding according to claim 11,
wherein the decorative film for molding is a decorative film for molding used for decorating a housing panel of an electronic device.

15. A molded product obtained by molding the decorative film for molding according to claim 13.

16. The molded product according to claim 15, comprising a plurality of regions which are different from each other in terms of a photoisomerization proportion of the photoisomerization compound, and having at least two regions, wherein a difference in wavelength of a maximum reflectance between the at least two regions is 50 nm or more.

17. An automobile exterior plate comprising:
the molded product according to claim 15.

18. An electronic device comprising:
the molded product according to claim 15.
